(19) United States
(12) Patent Application Publication
(10) Pub. No.: US 2024/0161254 A1
(43) Pub. Date: May 16, 2024

(54) INFORMATION PROCESSING APPARATUS, INFORMATION PROCESSING METHOD, AND PROGRAM

(71) Applicant: SONY SEMICONDUCTOR SOLUTIONS CORPORATION, KANAGAWA (JP)

(72) Inventors: NORIBUMI SHIBAYAMA, KANAGAWA (JP); TAKAHIKO YOSHIDA, KANAGAWA (JP); HIDESHI YAMADA, KANAGAWA (JP)

(21) Appl. No.: 18/550,653

(22) PCT Filed: Jan. 20, 2022
(86) PCT No.: PCT/JP2022/001918

§ 371 Date: Sep. 14, 2023

(30) Foreign Application Priority Data
Mar. 25, 2021 (JP) 2021-051097

(51) Int. Cl. G06T 5/77; G06T 7/12; G06T 7/50; G06V 10/56; G06V 10/75; G06V 10/764

(52) U.S. Cl. CPC G06T 5/77; G06T 7/12; G06T 7/50; G06V 10/56; G06V 10/758; G06V 10/764; G06T 2207/20084; G06V 2201/07

(57) ABSTRACT

The present disclosure relates to an information processing apparatus, an information processing method, and a program capable of more appropriately processing a correction target pixel when sensor fusion is used. Provided is an information processing apparatus including a processing unit that performs processing using a learned model learned by machine learning on at least a part of a first image in which an object acquired by a first sensor is indicated by depth information, a second image in which an image of the object acquired by a second sensor is indicated by plane information, and a third image obtained from the first image and the second image to specify a correction target pixel included in the first image. The present disclosure can be applied to, for example, a device having a plurality of sensors.

### TECHNICAL FIELD

The present disclosure relates to information processing apparatuses, information processing methods, and programs, and more particularly to an information processing apparatus, an information processing method, and a program enabling a correction target pixel to be more appropriately processed when a sensor fusion is used.

### BACKGROUND ART

In recent years, research and development on sensor fusion in which a plurality of sensors having different detection principles is combined and measurement results thereof are fused are being actively conducted.

Patent Document 1 discloses a technology of detecting a defective pixel in depth measurement data, defining a depth correction of the detected defective pixel, and applying the depth correction to the depth measurement data of the detected defective pixel in order to enhance the quality of depth map.

### CITATION LIST

### Patent Document

Patent Document 1: Japanese Translation of PCT Application No. 2014-524016

### SUMMARY OF THE INVENTION

### Problems to be Solved by the Invention

When sensor fusion is used, a correction target pixel such as a defective pixel may be included in an image to be processed, and it is required to more appropriately process the correction target pixel.

The present disclosure has been made in view of such circumstances, and enables a correction target pixel to be more appropriately processed when the sensor fusion is used.

### Solutions to Problems

An information processing apparatus according to a first aspect of the present disclosure is an information processing apparatus including a processing unit that performs processing using a learned model learned by machine learning on at least a part of a first image in which an object acquired by a first sensor is indicated by depth information, a second image in which an image of the object acquired by a second sensor is indicated by plane information, and a third image obtained from the first image and the second image to specify a correction target pixel included in the first image.

An information processing method and a program according to the first aspect of the present disclosure are an information processing method and a program adapted to the information processing apparatus according to the first aspect of the present disclosure described above.

In the information processing apparatus, the information processing method, and the program according to the first aspect of the present disclosure, the processing using the learned model learned by machine learning is performed on at least a part of a first image in which an object acquired by a first sensor is indicated by the depth information, a second image in which an image of the object acquired by a second sensor is indicated by plane information, and a third image obtained from the first image and the second image, and a correction target pixel included in the first image is specified.

An information processing apparatus according to a second aspect of the present disclosure is an information processing apparatus including a processing unit configured to acquire a first image in which an object acquired by a first sensor is indicated by depth information and a second image in which an image of the object acquired by a second sensor is indicated by plane information; generate the first image in a pseudo manner as a third image on the basis of the second image paired with the first image; compare the first image with the third image; and specify a correction target pixel included in the first image on the basis of a comparison result.

An information processing method and a program according to the second aspect of the present disclosure are an information processing method and a program adapted to the information processing apparatus according to the second aspect of the present disclosure described above.

In the information processing apparatus, the information processing method and the program according to the second aspect of the present disclosure, a first image in which an object acquired by a first sensor is indicated by depth information and a second image in which an image of the object acquired by a second sensor is indicated by plane information are acquired; the first image is generated in a pseudo manner as a third image on the basis of the second image paired with the first image; the first image is compared with the third image; and a correction target pixel included in the first image is specified on the basis of a comparison result.

An information processing apparatus according to a third aspect of the present disclosure is an information processing apparatus including a processing unit that generates a third image by mapping a first image in which an object acquired by a first sensor is indicated by depth information onto an image plane of a second image in which an image of the object acquired by a second sensor is indicated by color information, in which the processing unit is configured to map a first position on an image plane of the second image on the basis of depth information of the first position corresponding to each pixel of the first image, specify, as a pixel correction position, a second position to which depth information of the first position is not assigned among second positions corresponding to respective pixels of the second image, and infer depth information of the pixel correction position in the second image by using a learned model learned by machine learning.

An information processing method and a program according to the third aspect of the present disclosure are an information processing method and a program adapted to the information processing apparatus according to the third aspect of the present disclosure described above.

In the information processing apparatus, the information processing method and the program according to the third aspect of the present disclosure, when generating a third image by mapping a first image in which an object acquired by a first sensor is indicated by depth information onto an image plane of a second image in which an image of the object acquired by a second sensor is indicated by color information, a first position is mapped on an image plane of the second image on the basis of depth information of the first position corresponding to each pixel of the first image, a second position to which depth information of the first position is not assigned is specified as a pixel correction position among second positions corresponding to respective pixels of the second image, and depth information of the pixel correction position in the second image is inferred by using a learned model learned by machine learning.

An information processing apparatus according to a fourth aspect of the present disclosure is an information processing apparatus including a processing unit that generates a third image by mapping a second image in which an image of an object acquired by a second sensor is indicated by color information onto an image plane of a first image in which the object acquired by a first sensor is indicated by depth information, in which the processing unit is configured to specify, as a pixel correction position, a first position to which valid depth information is not assigned among first positions corresponding to respective pixels of the first image, infer depth information of the pixel correction position in the first image using a learned model learned by machine learning, and sample color information from a second position in the second image on the basis of depth information assigned to the first position to map the second position to the image plane of the first image.

An information processing method and a program according to a fourth aspect of the present disclosure are an information processing method and a program adapted to the information processing apparatus according to the fourth aspect of the present disclosure described above.

In the information processing apparatus, the information processing method and the program according to the fourth aspect of the present disclosure, when generating a third image by mapping a second image in which an image of an object acquired by a second sensor is indicated with color information onto an image plane of a first image in which the object acquired by a first sensor is indicated by depth information, a first position to which valid depth information is not assigned is specified as a pixel correction position among first positions corresponding to respective pixels of the first image, depth information of the pixel correction position in the first image is inferred using a learned model learned by machine learning, and color information is sampled from a second position in the second image on the basis of depth information assigned to the first position to map the second position to the image plane of the first image.

Note that the information processing apparatuses according to the first to fourth aspects of the present disclosure may be independent devices, or may be internal blocks constituting one device.

### BRIEF DESCRIPTION OF DRAWINGS

FIG. 1 is a diagram illustrating a configuration example of an information processing apparatus to which the present technology is applied.

FIG. 2 is a diagram illustrating a configuration example of a learning device that performs processing at the time of learning in a case where supervised learning is used.

FIG. 3 is a diagram illustrating a first example of a structure and output of a DNN for sensor fusion.

FIG. 4 is a diagram illustrating a second example of a structure and output of a DNN for sensor fusion.

FIG. 5 is a diagram illustrating a configuration example of a processing unit that performs processing at the time of inference in a case where supervised learning is used.

FIG. 6 is a diagram illustrating a configuration example of a learning device that performs processing at the time of learning in a case where unsupervised learning is used.

FIG. 7 is a diagram illustrating a configuration example of a processing unit that performs processing at the time of inference in a case where unsupervised learning is used.

FIG. 8 is a diagram illustrating a configuration example of a processing unit that performs processing at the time of inference.

FIG. 9 is a diagram illustrating a detailed configuration example of a specifying unit in the processing unit.

FIG. 10 is a diagram illustrating an example of generating a depth image using the GAN.

FIG. 11 is a flowchart illustrating a flow of a specific process.

FIG. 12 is a flowchart describing a flow of a correction process.

FIG. 13 is a diagram illustrating a configuration example of a processing unit that performs processing at the time of inference.

FIG. 14 is a diagram illustrating an example of an RGB image and a depth image.

FIG. 15 is a diagram illustrating configuration examples of a learning device and an inference unit in a case where supervised learning is used.

FIG. 16 is a diagram illustrating configuration examples of a learning device and an inference unit in a case where unsupervised learning is used.

FIG. 17 is a flowchart describing a flow of a first example of an image generation process.

FIG. 18 is a flowchart describing a flow of a second example of the image generation process.

FIG. 19 illustrates a first example of a use case to which the present disclosure can be applied.

FIG. 20 illustrates a second example of a use case to which the present disclosure can be applied.

FIG. 21 illustrates a third example of a use case to which the present disclosure can be applied.

FIG. 22 is a diagram illustrating a configuration example of a system including a device that performs AI processing.

FIG. 23 is a block diagram illustrating a configuration example of an electronic device.

FIG. 24 is a block diagram illustrating a configuration example of an edge server or a cloud server.

FIG. 25 is a block diagram illustrating a configuration example of an optical sensor.

FIG. 26 is a block diagram illustrating a configuration example of a processing unit.

FIG. 27 is a diagram illustrating a flow of data between a plurality of devices.

### MODE FOR CARRYING OUT THE INVENTION

### Configuration Example of Device

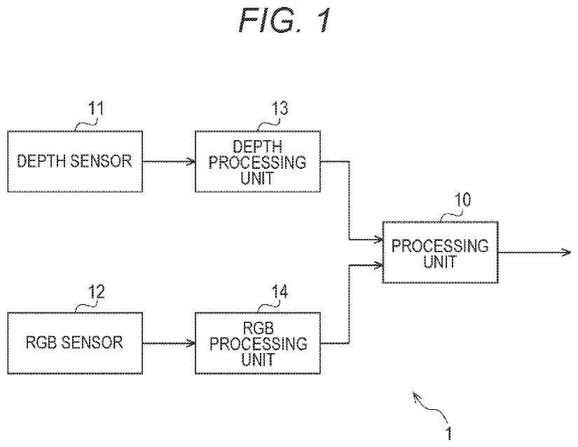

FIG. 1 is a diagram illustrating a configuration example of an information processing apparatus to which the present technology is applied.

An information processing apparatus 1 has a function related to sensor fusion that combines a plurality of sensors and fuses the measurement results. In FIG. 1, the information processing apparatus 1 is configured to include a processing unit 10, a depth sensor 11, an RGB sensor 12, a depth processing unit 13, and an RGB processing unit 14.

The depth sensor 11 is a distance measuring sensor such as a time of flight (ToF) sensor. The ToF sensor may be either a direct time of flight (dToF) method or an indirect time of flight (iToF) method. The depth sensor 11 measures the distance to the object and supplies a distance measuring signal obtained as a result to the depth processing unit 13. Note that the depth sensor 11 may be a structure light type sensor, a light detection and ranging (LiDAR) type sensor, a stereo camera, or the like.

The depth processing unit 13 is a signal processing circuit such as a DSP. The depth processing unit 13 performs signal processing such as depth development processing or depth preprocessing (e.g., resizing processing etc.), on the distance measuring signal supplied from the depth sensor 11, and supplies depth image data obtained as a result to the processing unit 10. The depth image is an image indicating the object by depth information. Note that the depth processing unit 13 may be included in the depth sensor 11.

The RGB sensor 12 is an image sensor such as a complementary metal oxide semiconductor (CMOS) image sensor or a charge coupled device (CCD) image sensor. The RGB sensor 12 images an image of an object and supplies an imaging signal obtained as a result to the RGB processing unit 14. Note that the RGB sensor 12 is not limited to the RGB camera, and may be a monochrome camera, an infrared camera, or the like.

The RGB processing unit 14 is a signal processing circuit such as a digital signal processor (DSP). The RGB processing unit 14 performs signal processing such as RGB development processing or RGB preprocessing (e.g., resizing processing or the like), on the imaging signal supplied from the RGB sensor 12, and supplies RGB image data obtained as a result to the processing unit 10. The RGB image is an image indicating an image of an object by color information (surface information). Note that the RGB processing unit 14 may be included in the RGB sensor 12.

The processing unit 10 includes a processor such as a central processing unit (CPU). The depth image data from the depth processing unit 13 and the RGB image data from the RGB processing unit 14 are supplied to the processing unit 10.

The processing unit 10 performs processing using a learned model (learning model) learned by machine learning on at least a part of the depth image data, the RGB image data, and the image data obtained from the depth image data and the RGB image data. Hereinafter, details of processing using the learning model performed by the processing unit 10 will be described.

### 1. First Embodiment

When the depth image is generated using the ToF sensor as the depth sensor 11, abnormal pixels called flying pixels may be included. Due to this abnormal pixel, the accuracy of the recognition processing using the depth image may lower. Therefore, hereinafter, a method of specifying a correction target pixel such as a flying pixel or a defective pixel included in a depth image using a learned model learned by machine learning will be described. Here, in using machine learning, a case of supervised learning and a case of unsupervised learning will be described.

(A) Supervised learning

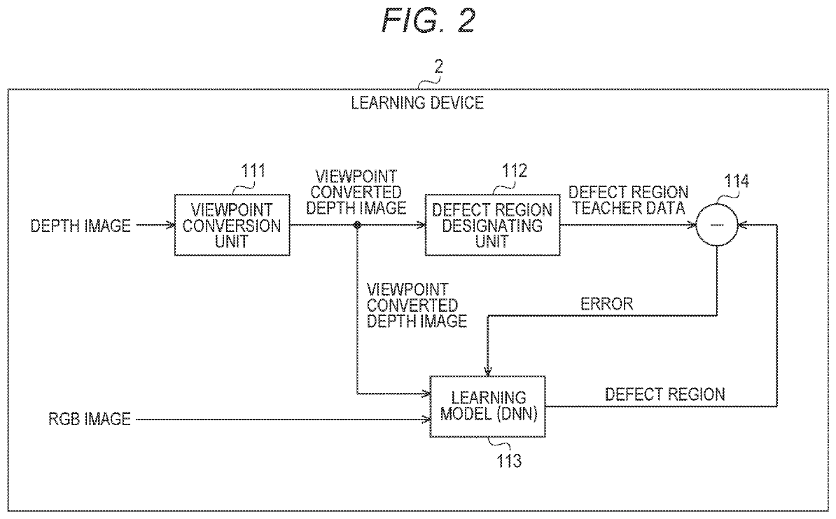

FIG. 2 is a diagram illustrating a configuration example of a learning device that performs processing at the time of learning in a case where supervised learning is used.

In FIG. 2, the learning device 2 includes a viewpoint conversion unit 111, a defect region designating unit 112, a learning model 113, and a subtraction unit 114.

The depth image and the RGB image are input to the learning device 2 as learning data, and the depth image is supplied to the viewpoint conversion unit 111 and the RGB image is supplied to the learning model 113. However, the depth image input here includes a defect region (defective pixel).

The viewpoint conversion unit 111 performs the viewpoint conversion process on the input depth image, and supplies a viewpoint converted depth image, which is a depth image in which the viewpoint is converted obtained as a result, to the defect region designating unit 112 and the learning model 113.

As the viewpoint conversion processing, process of converting the depth image obtained from the distance measuring signal from the depth sensor 11 into the viewpoint of the RGB sensor 12 is performed using the photographing parameter, and the viewpoint converted depth image that is the viewpoint of the RGB sensor 12 is generated. As the photographing parameter, for example, information associated with the relative position and posture between the depth sensor 11 and the RGB sensor 12 is used.

The defect region designating unit 112 generates the defect region teacher data by designating the defect region in the viewpoint converted depth image supplied from the viewpoint conversion unit 111, and supplies the defect region teacher data to the subtraction unit 114.

For example, when the user visually designates a defect region (e.g., a region of defective pixel) as the annotation work, an image in which the defect region is filled, coordinates of the defect region (defective pixel) in the viewpoint converted depth image, or the like is generated as the defect region teacher data. As the coordinates of the defect region or the defective pixel, for example, coordinates representing a rectangle or a point can be used.

The learning model 113 is a model that performs machine learning by a deep neural network (DNN) having the RGB image and the viewpoint converted depth image as inputs and a defect region as an output. DNN is a machine learning method by a multilayer artificial neural network among deep learning that learns concepts of granularity from an entire image to details of an object in association with each other as a hierarchical structure.

In addition, the subtraction unit 114 calculates a difference (deviation) between the defect region that is the output of the learning model 113 and the defect region teacher data from the defect region designating unit 112, and feeds back the difference to the learning model 113 as an error of the defect region. In the learning model 113, the weight and the like of each neuron of the DNN are adjusted using back propagation (error reverse propagation method) so as to reduce the error from the subtraction unit 114.

That is, in the learning model 113, when the RGB image and the viewpoint converted depth image are input, it is expected that the defect region is output as an output, but at an initial stage of learning, a region different from the defect region is output as the defect region. Here, by repeatedly feeding back the difference (deviation) between the defect region output from the learning model 113 and the defect region teacher data, as the learning progresses, the defect region which is the output of the learning model 113 is gradually output as the defect region teacher data, and the learning of the learning model 113 converges.

As a basic structure of the DNN in the learning model 113, for example, a DNN for semantic segmentation such as FuseNet (described in Document 1 below) or a DNN for object detection such as a single shot multibox detector (SSD) or You Only Look Once (YOLO) can be used.

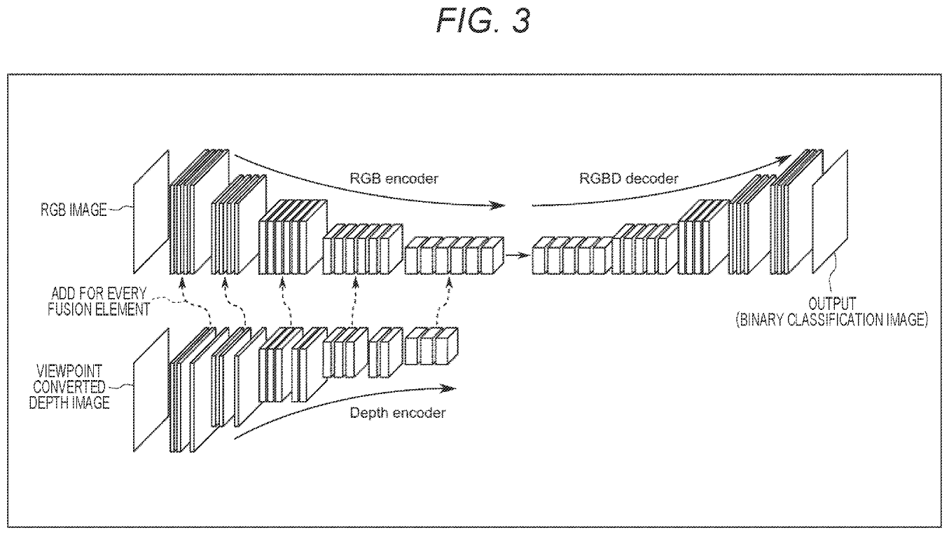

FIG. 3 illustrates an example of outputting a binary classification image by semantic segmentation as an example of the structure and output of a DNN for sensor fusion.

In FIG. 3, when the RGB image and the viewpoint converted depth image are input from the left side in the drawing, the feature amount obtained in stages by performing the convolution operation on the viewpoint converted depth image is added to the feature amount obtained in stages by performing the convolution operation on the RGB image. That is, feature amounts (matrices) are obtained in stages by performing the convolution operation for the RGB image and the viewpoint converted depth image, and addition is performed for each fusion element.

As a result, the depth image (viewpoint converted depth image) and the RGB image, which are two sensor outputs of the depth sensor 11 and the RGB sensor 12, are synthesized, and the binary classification image is output as an output of semantic segmentation. The binary classification image is an image in which a defect region (region of a defective pixel) and other regions are painted separately. For example, in the binary classification image, the defective pixel can be filled according to whether or not the pixel is a defective pixel.

Note that, as a technique related to semantic segmentation in sensor fusion, for example, there is a technique disclosed in the following Document 1.

Document 1: “FuseNet: Incorporating Depth into Semantic Segmentation via Fusion-based CNN Architecture”, Caner Hazirbas, Lingni Ma, Csaba Domokos, and Daniel Cremer <URL:https://hazirbas.com/projects/fusenet/>

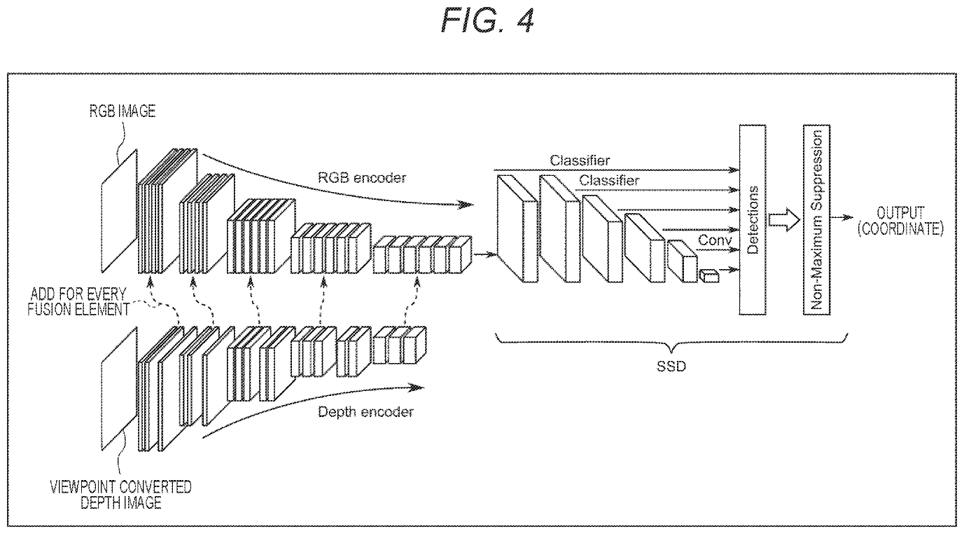

FIG. 4 illustrates an example of outputting numerical data such as coordinates of a defect region as an example of the structure and output of a DNN for sensor fusion.

In FIG. 4, similarly to FIG. 3, an RGB image and a viewpoint converted depth image are input from the left side in the drawing, a feature amount (matrix) is obtained in a stepwise manner by a convolution operation for each image, and is added for each fusion element. In addition, a structure of a single shot multibox detector (SSD) is illustrated in post-stage, and coordinates of a defect region (defective pixel) are output as an output thereof by inputting a feature amount obtained by adding for each fusion element or the like. As the coordinates of the defect region or the defective pixel, for example, coordinates (xy coordinates) representing a rectangle or a point are output.

Note that, as a technique related to object detection using the SSD, for example, there is a technique disclosed in the following Document 2.

Document 2: “SSD: single shot multibox detector”, W. Liu, D. Anguelov, D. Erhan, S. Christian, S. Reed, C.-Y. Fu, and A. C. Berg

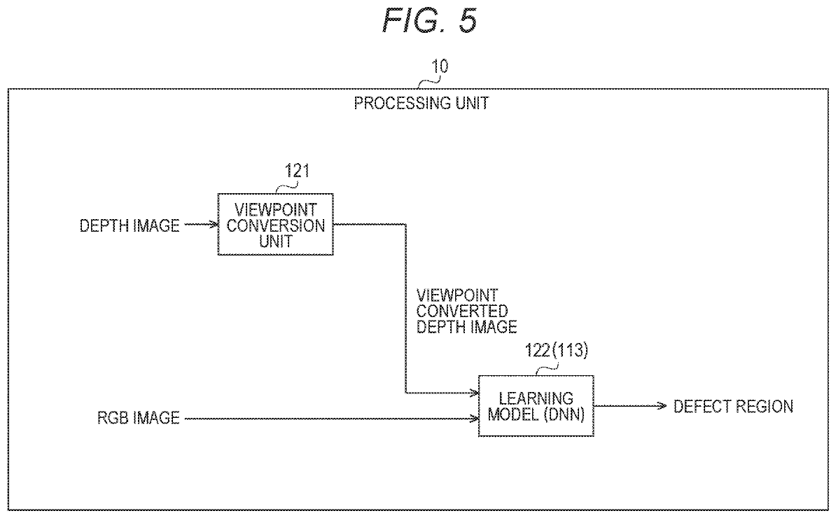

The learning model 113 learned by the DNN at the time of learning in this manner can be used as a learned model at the time of inference. FIG. 5 is a diagram illustrating a configuration example of a processing unit that performs processing at the time of inference in a case where supervised learning is used.

In FIG. 5, The processing unit 10 corresponds to the processing unit 10 in FIG. 1. The processing unit 10 includes a viewpoint conversion unit 121 and a learning model 122. However, the learning model 122 corresponds to the learning model 113 (FIG. 2) learned by learning with a DNN at the time of learning.

The depth image and the RGB image are input to the processing unit 10 as measurement data, and the depth image is supplied to the viewpoint conversion unit 121, and the RGB image is supplied to the learning model 122.

The viewpoint conversion unit 121 performs the viewpoint conversion process on the input depth image using the photographing parameter, and supplies the viewpoint converted depth image corresponding to the viewpoint of the RGB sensor 12 obtained as a result to the learning model 122.

The learning model 122 outputs the defect region by performing inference using the RGB image serving as the measurement data and the viewpoint converted depth image supplied from the viewpoint conversion unit 121 as inputs. That is, the learning model 122 corresponds to the learning model 113 (FIG. 2) learned by DNN at the time of learning, and when the RGB image and the viewpoint converted depth image are input, the binary classification image in which the defective pixel is filled, and the coordinates (xy coordinates representing a rectangle or a point) of the defect region or the defective pixel are output as the defect region that is the output.

(B) Unsupervised Learning

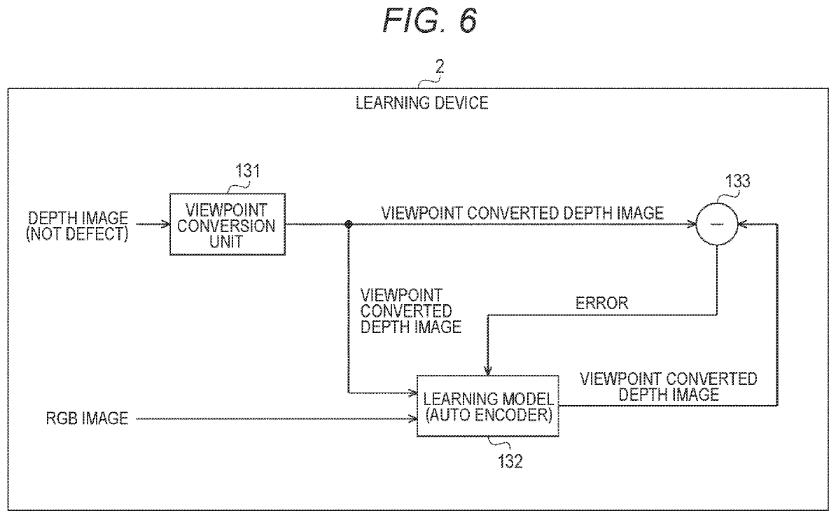

FIG. 6 is a diagram illustrating a configuration example of a learning device that performs processing at the time of learning in a case where unsupervised learning is used.

In FIG. 6, the learning device 2 includes a viewpoint conversion unit 131, a learning model 132, and a subtraction unit 133.

The depth image and the RGB image are input to the learning device 2 as learning data, and the depth image is supplied to the viewpoint conversion unit 131 and the RGB image is supplied to the learning model 132. However, the depth image input here is a depth image without defect.

The viewpoint conversion unit 131 performs the viewpoint conversion process on the depth image using the photographing parameter, and supplies the viewpoint converted depth image corresponding to the viewpoint of the RGB sensor 12 obtained as a result to the learning model 132 and the subtraction unit 133.

The learning model 132 is a model that performs machine learning by an autoencoder with an RGB image and a viewpoint converted depth image as inputs and a viewpoint converted depth image as an output. The auto encoder is one of neural networks, and is used for abnormality detection or the like by taking a difference between an input and an output, but in the learning model 132, adjustment is made such that a viewpoint converted depth image, which is data of the same format as the input viewpoint converted depth image, is output.

Furthermore, the subtraction unit 133 calculates a difference between the viewpoint converted depth image, which is the output of the learning model 132, and the viewpoint converted depth image from the viewpoint conversion unit 131, and feeds back the difference to the learning model 132 as an error of the viewpoint converted depth image. For example, as the difference between the viewpoint converted depth images, a difference in the values of the z coordinates can be used for each pixel in the image. In the learning model 132, the weight and the like of each neuron of the NN are adjusted using back propagation so as to reduce the error from the subtraction unit 133.

That is, in the learning model 132, the viewpoint converted depth image is output with the viewpoint converted depth image without defect as input, and the difference between the input viewpoint converted depth image and the output viewpoint converted depth image is fed back, which are repeatedly performed. As a result, in the learning model 132, the learning is performed by the auto encoder without knowing the depth image having a defect, and thus the viewpoint converted depth image in which the defect has disappeared is output as the output.

As a basic structure of the auto encoder in the learning model 132, for example, FuseNet described in Document 1 can be used. Specifically, in the case of the supervised learning described above, the binary classification image is output as the output of the semantic segmentation, but in the case of the unsupervised learning, the depth image (viewpoint converted depth image) is only required to be output as the output of the semantic segmentation.

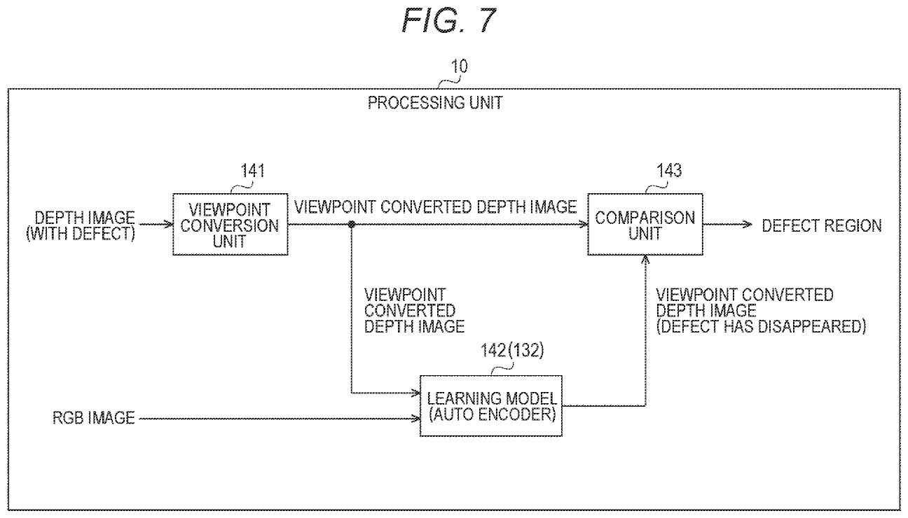

The learning model 132 learned by the auto encoder at the time of learning in this manner can be used as a learned model at the time of inference. FIG. 7 is a diagram illustrating a configuration example of a processing unit that performs processing at the time of inference in a case where unsupervised learning is used.

In FIG. 7, the processing unit 10 corresponds to the processing unit 10 in FIG. 1. The processing unit 10 includes a viewpoint conversion unit 141, a learning model 142, and a comparing unit 143. However, the learning model 142 corresponds to the learning model 132 (FIG. 6) learned by learning with an auto encoder at the time of learning.

The depth image and the RGB image are input to the processing unit 10 as measurement data, and the depth image is supplied to the viewpoint conversion unit 141, and the RGB image is supplied to the learning model 142. However, the depth image input here is a depth image having a defect (possibly having a defect).

The viewpoint conversion unit 141 performs the viewpoint conversion process on the depth image using the photographing parameter, and supplies the viewpoint converted depth image corresponding to the viewpoint of the RGB sensor 12 obtained as a result to the learning model 142 and the comparing unit 143.

The learning model 142 performs inference using the RGB image serving as measurement data and the viewpoint converted depth image supplied from the viewpoint conversion unit 141 as inputs, and supplies the viewpoint converted depth image serving as an output to the comparing unit 143. That is, the learning model 142 corresponds to the learning model 132 (FIG. 6) learned by the auto encoder at the time of learning, and when the RGB image and the viewpoint converted depth image are input, the viewpoint converted depth image in which the defect has disappeared is output as the viewpoint converted depth image which is the output thereof.

The comparing unit 143 compares the viewpoint converted depth image supplied from the viewpoint conversion unit 141 with the viewpoint conversion depth image supplied from the learning model 142, and outputs the comparison result as a defect region. That is, there is a possibility that the viewpoint converted depth image from the viewpoint conversion unit 141 has a defect, but since the viewpoint conversion depth image output from the learning model 142 has no defect (the defect disappears), the comparing unit 143 compares these viewpoint converted depth images to obtain a defect region.

Specifically, for example, for each pixel in the two viewpoint converted depth images to be compared, a ratio of values (distance value) of the Z coordinate of both is calculated, and a pixel in which the calculated ratio is greater than or equal to a predetermined threshold value (or less than the threshold value) can be regarded as a defective pixel. The comparing unit 143 can output the XY coordinates in the image as the defect region for the pixel regarded as the defective pixel.

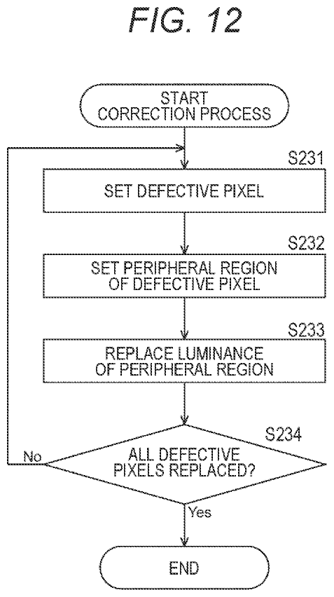

As described above, in the first embodiment, the defect region (defective pixel) included in the depth image can be output using the learned model learned by machine learning. The defective pixel included in the defect region can be corrected as a correction target pixel by the post-stage process. For example, the correction process (FIG. 12) to be described later can be applied to a correction target pixel such as a defective pixel. Alternatively, in the post-stage process, the correction target pixel such as the defective pixel may be ignored as invalid without being corrected. Note that a depth image in which a correction target pixel such as a defective pixel is corrected may be output as the output of the learned model.

In this way, by specifying a correction target pixel such as a defective pixel, it is possible to perform processes such as correcting the correction target pixel or ignoring the correction target pixel as invalid, and for example, in the recognition processing using the subsequent depth image, the accuracy of the recognition processing can be improved.

### 2. Second Embodiment

When a correction target pixel such as a defective pixel included in the depth image is specified, a depth image generated in a pseudo manner using GAN (Generative Adversarial Networks) or the like can be used. Hereinafter, a method of specifying a correction target pixel such as a defective pixel and a method of correcting the specified correction target pixel using a depth image generated by the GAN will be described.

### Configuration Example of Processing Unit

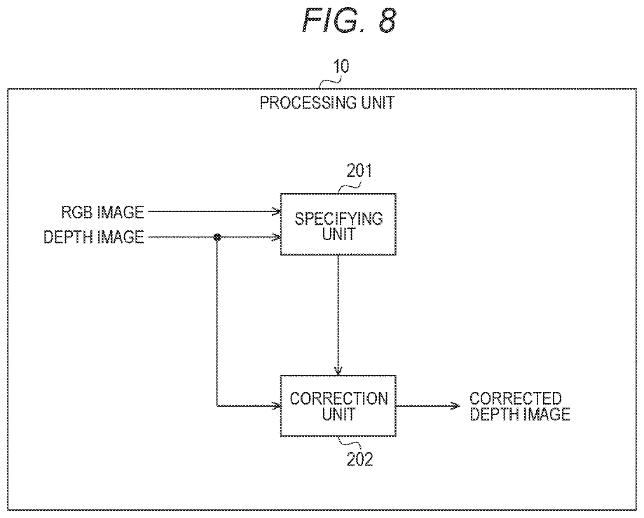

FIG. 8 is a diagram illustrating a configuration example of a processing unit that performs processing at the time of inference.

In FIG. 8, the processing unit 10 corresponds to the processing unit 10 in FIG. 1. The processing unit 10 includes a specifying unit 201 and a correction unit 202.

The RGB image and the depth image are input to the processing unit 10 as measurement data, and the RGB image and the depth image are supplied to the specifying unit 201, and the depth image is supplied to the correction unit 202.

The specifying unit 201 performs inference using a learned model learned by machine learning on at least a part of the input RGB image, and specifies a defect region (defective pixel) included in the input depth image. The specifying unit 201 supplies a specification result of the defect region (defective pixel) to the correction unit 202.

The correction unit 202 corrects the defect region (defective pixel) included in the input depth image on the basis of the specification result of the defect region (defective pixel) supplied from the specifying unit 201. The correction unit 202 outputs the corrected depth image.

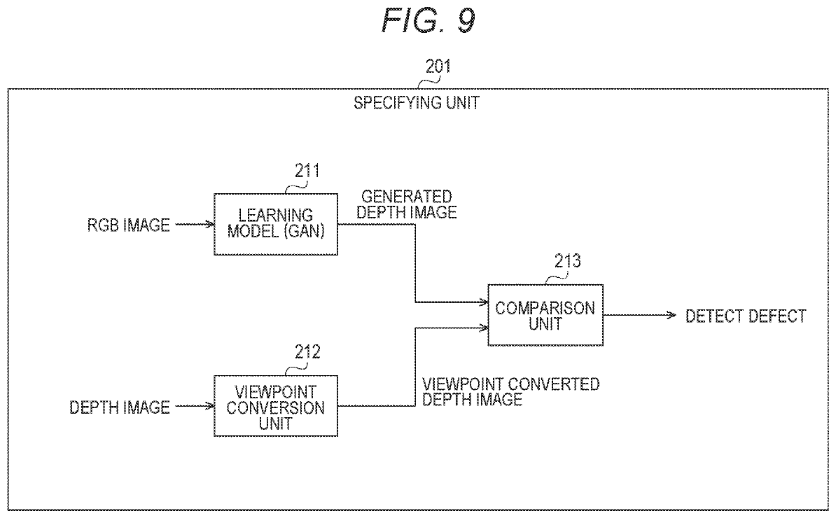

Hereinafter, a detailed configuration of the specifying unit 201 will be described with reference to FIG. 9. In FIG. 9, the specifying unit 201 includes a learning model 211, a viewpoint conversion unit 212, and a comparing unit 213.

The RGB image and the depth image are input to the specifying unit 201 as measurement data, and the RGB image is supplied to the learning model 211 and the depth image is supplied to the viewpoint conversion unit 212, respectively.

The learning model 211 is a learned model obtained by learning the correspondence relationship between the depth image and the RGB image paired with the depth image by machine learning such as GAN. The learning model 211 generates a depth image from the input RGB image and supplies the generated depth image to the comparing unit 213 as an output thereof. Here, the depth image generated using the learning model 211 is referred to as a generated depth image, and is distinguished from the depth image acquired by the depth sensor 11.

The viewpoint conversion unit 212 performs the process of converting the depth image into the viewpoint of the RGB sensor 12 using the photographing parameter, and supplies the viewpoint converted depth image obtained as a result to the comparing unit 213. As the photographing parameter, for example, information associated with the relative position and posture between the depth sensor 11 and the RGB sensor 12 is used.

The generated depth image from the learning model 211 and the viewpoint converted depth image from the viewpoint conversion unit 212 are supplied to the comparing unit 213. The comparing unit 213 compares the generated depth image with the viewpoint converted depth image, and outputs a comparison result assuming that a defective pixel is detected when the comparison result satisfies a predetermined condition.

For example, the comparing unit 213 can obtain a difference in luminance for each corresponding pixel between the generated depth image and the viewpoint converted depth image, determine whether the absolute value of the luminance difference is greater than or equal to a predetermined threshold value, and determine a pixel in which the absolute value of the luminance difference is greater than or equal to the predetermined threshold value as a defect candidate pixel (defective pixel).

Furthermore, in the above description, the case where the threshold value determination is performed by taking the difference in luminance for each pixel when the generated depth image and the viewpoint conversion depth image are compared by the comparing unit 213 has been described. However, the present invention is not limited to the difference in luminance, and for example, other calculation values such as a ratio of luminance for each pixel may be used.

Here, the reason why a pixel having a luminance difference or a luminance ratio of greater than or equal to a predetermined threshold value is set as a defect candidate pixel is as follows. That is, in a case where the generated depth image generated using the learned model learned by the GAN or the like is generated as expected, the generated depth image is similar to the depth image, and thus, a pixel having a large luminance difference or a large luminance ratio is regarded as a defective pixel.

(Image Generation by GAN)

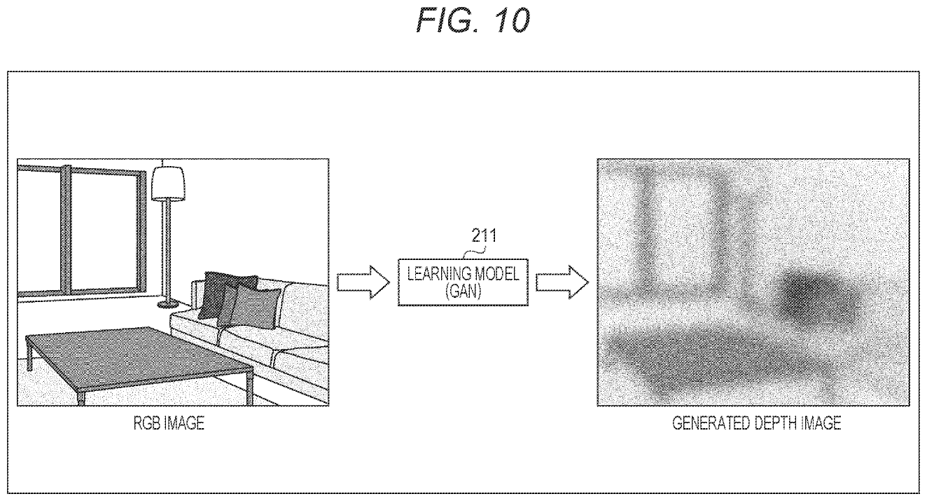

FIG. 10 illustrates an example in which the generated depth image is generated from the RGB image using the learning model 211 learned by learning using the GAN.

The GAN learns a highly accurate generation model by using two networks called a generation network (generator) and an identification network (discriminator) and causing them to compete with each other.

For example, the generation network generates a learning sample (generated depth image) that looks real so as to deceive the identification network from appropriate data (RGB image), while the identification network determines whether a given sample is real or has been generated by the generation network. The generation network can ultimately generate samples (generated depth images) that are as similar as possible to the real thing from the appropriate data (RGB images) by causing these two models to learn.

Furthermore, in the learning model 211 as well, machine learning using two networks of a generation network and an identification network has been performed at the time of learning, and as illustrated in FIG. 10, a generated depth image can be output by inputting an RGB image at the time of inference.

Note that, as a technique for generating a depth image from an RGB image, for example, there is a technique disclosed in Document 3 below.

Document 3: “Depth Map Prediction from a Single Image using a Multi-Scale Deep Network”, David Eigen, Christian Puhrsch, Rob Fergus

Furthermore, the learning model 211 is not limited to the GAN, and machine learning may be performed by another neural network such as a variational autoencoder (VAE), and the generated depth image may be generated from the input RGB image at the time of inference.

(Specific Process)

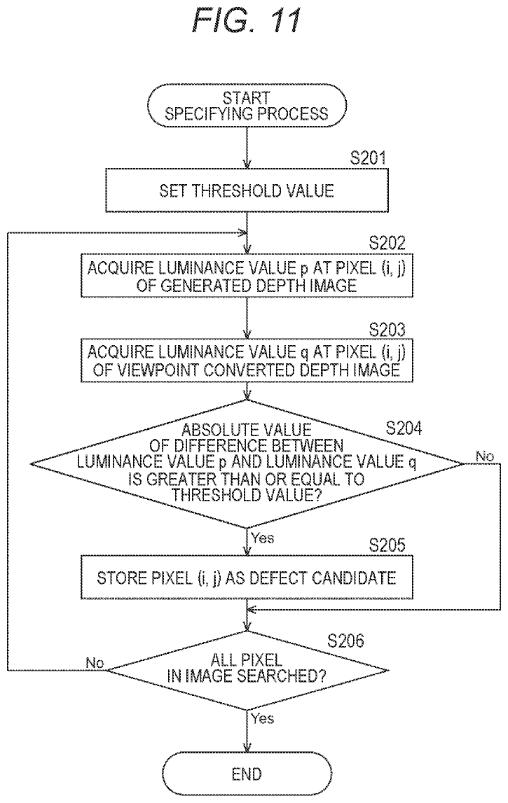

A flow of a specific process by the specifying unit 201 will be described with reference to a flowchart in FIG. 11.

In step S201, the comparing unit 213 sets a threshold value Th used for determination of a defect candidate pixel.

In step S202, the comparing unit 213 acquires the luminance value p in the pixel (i, j) of the generated depth image output from the learning model 211. Furthermore, in step S203, the comparing unit 213 acquires the luminance value q in the pixel (i, j) of the viewpoint converted depth image from the viewpoint conversion unit 212.

Here, i rows and j columns of pixels in each image are expressed as pixels (i, j), and the pixels (i, j) of the generated depth image and the pixels (i, j) of the viewpoint converted depth image indicate pixels existing at corresponding positions (same coordinates) in those images.

In step S204, comparing unit 213 determines whether an absolute value of a difference between luminance value p and luminance value q is greater than or equal to the threshold value Th. That is, whether the relationship of the following expression (1) is satisfied is determined.

|p−q|≥Th (1)

In a case where the comparing unit 213 determines that the absolute value of the difference between the luminance value p and the luminance value q is greater than or equal to the threshold value Th in step S204, the process proceeds to step S205. In step S205, the comparing unit 213 stores a pixel (i, j) to be compared as a defect candidate. For example, information (e.g., coordinates) associated with a defect candidate pixel can be held in a memory as pixel correction position information.

On the other hand, in a case where the absolute value of the difference between the luminance value p and the luminance value q is less than the threshold value Th in step S204, the process in step S205 is skipped.

In step S206, whether or not all the pixels in the image have been searched is determined. In a case where it is determined that all the pixels in the image have not been searched in step S206, the process returns to step S202, and the processes in step S202 and subsequent steps are repeated.

By repeating the processes of steps S202 to S206, the threshold value determination of the difference between the luminance values is performed for all the corresponding pixels in the generated depth image and the viewpoint converted depth image, and all the defect candidate pixels included in the image are specified and the information thereof are held.

In a case where it is determined that all the pixels in the image have been searched in step S206, the series of processes are ended.

The flow of the specifying process has been described above. In this specifying process, all pixels to be defect candidate pixels are specified from the pixels included in the depth image.

(Correction Process)

Next, a flow of a correction process by the correction unit 202 will be described with reference to a flowchart of FIG. 12. Note that the correction unit 202 generates a viewpoint converted depth image from the input depth image, and performs processing on the viewpoint converted depth image. The viewpoint converted depth image may be supplied from the specifying unit 201.

In step S231, the correction unit 202 sets the defective pixel. Here, the defect candidate pixel stored in the process of step S205 in FIG. 11 is set as a defective pixel. For example, pixel correction position information held in a memory can be used when setting a defective pixel.

In step S232, the correction unit 202 sets a peripheral region of the defective pixel in the viewpoint converted depth image. For example, an N×N square region including a defective pixel can be set as a peripheral region. The value of N can be set to an arbitrary value in units of pixels, and for example, N=5 can be set. Note that not only the square region but also a region having other shapes such as a rectangle may be set as the peripheral region.

In step S233, the correction unit 202 replaces the luminance of the peripheral region of the defective pixel in the viewpoint converted depth image. As a method of replacing the luminance of the peripheral region, for example, one of the following two methods can be used.

First of all, there is a method of calculating a median value of luminance values of pixels excluding a defective pixel among pixels included in a peripheral region in a viewpoint converted depth image serving as measurement data, and replacing the luminance value of the peripheral region with the median value of the calculated luminance value. Here, the influence of noise can be suppressed in replacing the luminance by using the median value of the luminance value, but other statistics such as an average value may be used.

Secondly, there is a method of replacing the luminance value of the peripheral region with the luminance value of the region corresponding to the peripheral region in the generated depth image, which is the output from the learning model 211. That is, since the generated depth image is a pseudo depth image generated using the learning model 211 learned by the GAN or the like, there is no unnatural region such as a defect, and thus, it can be used to replace the luminance of the peripheral region.

In step S234, whether or not all the defective pixels have been replaced is determined. In a case where it is determined that all the defective pixels in the image have not been replaced in step S234, the process returns to step S231, and the processes in step S231 and subsequent steps are repeated.

All (the peripheral region including) the defective pixels included in the viewpoint converted depth image are corrected by repeating the processes of steps S231 to S234.

In a case where it is determined that all the defective pixels in the image have been replaced in step S234, the series of processes are ended.

The flow of the correction process has been described above. In this correction process, a defective pixel serving as a correction target pixel is set, and (a region including) the correction target pixel is corrected by replacing the luminance of the peripheral region. Then, the depth image (viewpoint converted depth image) in which the correction target pixel is corrected is output.

As described above, in the second embodiment, the correction target pixel such as the defective pixel can be specified and corrected using the depth pixel pseudo-generated using the GAN or the like. Therefore, for example, the accuracy of the recognition processing can be improved in the recognition processing using the subsequent depth image.

### 3. Third Embodiment

When an RGBD image is generated from an RGB image and a depth image, there are a case where a depth value (distance value) is not assigned, and a case where a correct depth value is not assigned even if the depth value is assigned. Examples of the factor that the depth value is not assigned include shielding or saturation due to parallax, and a low reflectance object or a transparent object being an object. Examples of the factor that the correct depth value is not assigned include a case where the object is multipath, a mirror surface, a translucent object, a high contrast pattern, and the like.

Therefore, a method for generating an RGBD image without a defect from the RGB image and the depth image has been required. Hereinafter, a method of generating an RGBD image without a defect from the RGB image and the depth image using a learned model learned by machine learning will be described.

### Configuration Example of Processing Unit

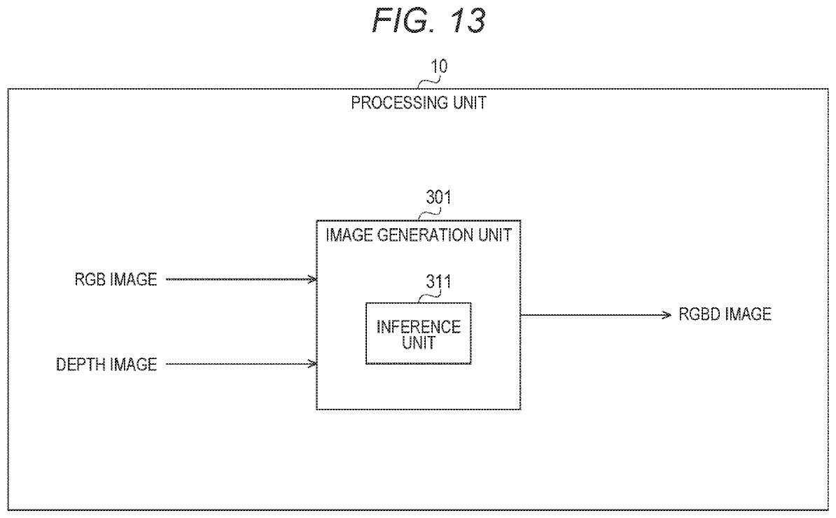

FIG. 13 is a diagram illustrating a configuration example of a processing unit that performs processing at the time of inference.

In FIG. 13, the processing unit 10 corresponds to the processing unit 10 in FIG. 1. The processing unit 10 includes an image generation unit 301.

The RGB image and the depth image are input to the processing unit 10 as measurement data, and are supplied to the image generation unit 301.

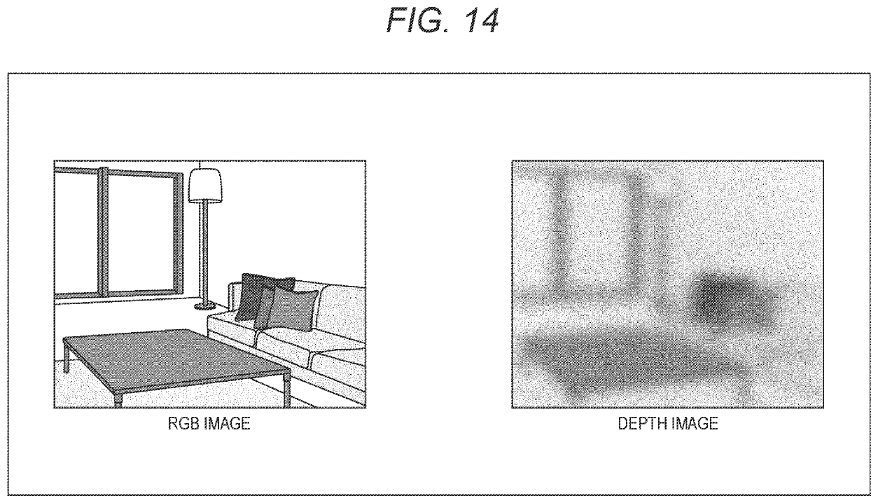

The image generation unit 301 generates an RGBD image having RGB color information and depth information based on a depth value (D value) from the input RGB image and depth image. When generating the RGBD image, the RGBD image can be generated by mapping the depth image to the image plane of the RGB image or by mapping the RGB image to the image plane of the depth image. For example, an RGB image and a depth image as illustrated in FIG. 14 are synthesized to generate an RGBD image.

The image generation unit 301 includes an inference unit 311. Using the learned learning model, the inference unit 311 performs inference using an RGBD image or the like having a defect in the depth value as an input, and outputs an RGBD image or the like in which the defect is corrected. Hereinafter, a case where learning is performed by supervised learning and a case where learning is performed by unsupervised learning at the time of learning will be described as learning models used by the inference unit 311.

(A) Supervised Learning

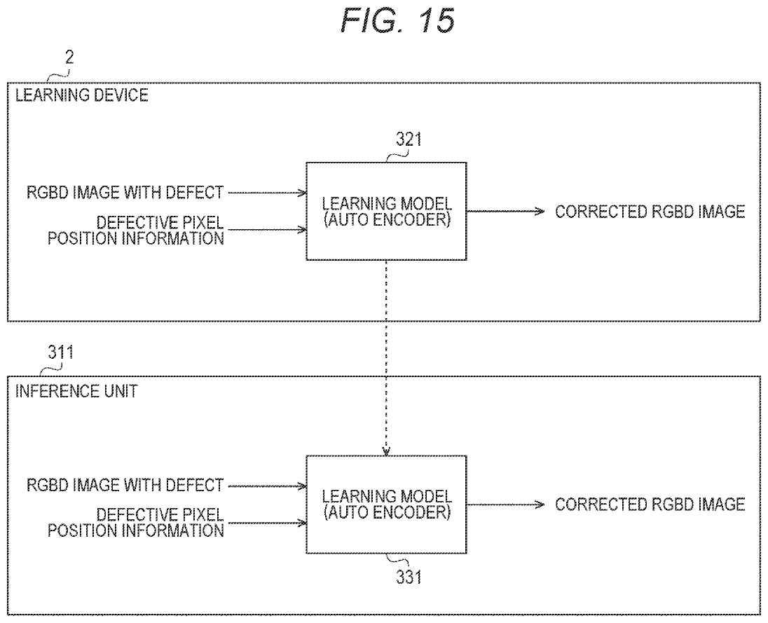

FIG. 15 illustrates a configuration example of a learning device that performs processing at the time of learning and an inference unit that performs processing at the time of inference in a case where supervised learning is used.

In FIG. 15, a learning device 2 that performs processing at the time of learning is illustrated in the upper part, and an inference unit 311 that performs processing at the time of inference is illustrated in the lower part. The inference unit 311 corresponds to the inference unit 311 in FIG. 13.

In FIG. 15, the learning device 2 includes a learning model 321. The learning model 321 is a model that performs machine learning by a neural network that receives an RGBD image having a defect in the depth value and pixel position information (defective pixel position information) indicating the position of a defective pixel as inputs and outputs the RGBD image. For example, in the learning model 321, by repeating learning in which an RGBD image having a defect in the depth value and defective pixel position information are used as learning data, and information regarding correction of (a region including) the defective pixel position is used as teacher data, an RGBD image in which the defect is corrected can be output as an output. As the neural network, for example, an auto encoder, a DNN, or the like can be used.

The learning model 321 learned by machine learning at the time of learning in this manner can be used at the time of inference as the learned model.

In FIG. 15, the inference unit 311 includes a learning model 331. The learning model 331 corresponds to the learning model 321 learned by learning through machine learning at the time of learning.

The learning model 331 outputs the RGBD image in which the defect has been corrected by performing inference using the RGBD image having a defect in the depth value and the defective pixel position information as inputs. Here, the RGBD image having a defect in the depth value is an RGBD image generated from the RGB image and the depth image serving as measurement data. The defective pixel position information is information associated with a position of a defective pixel specified from an RGB image and a depth image serving as measurement data.

Note that other machine learning may be performed as the supervised learning. For example, at the time of learning, the learning may be performed such that information regarding a pixel position in which a defect has been corrected is output as an output of the learning model 321, and, at the time of inference, the learning model 331 may perform inference using an RGBD image having a defect in the depth value and the defective pixel position information as inputs and output information regarding a pixel position in which a defect has been corrected.

(B) Unsupervised Learning

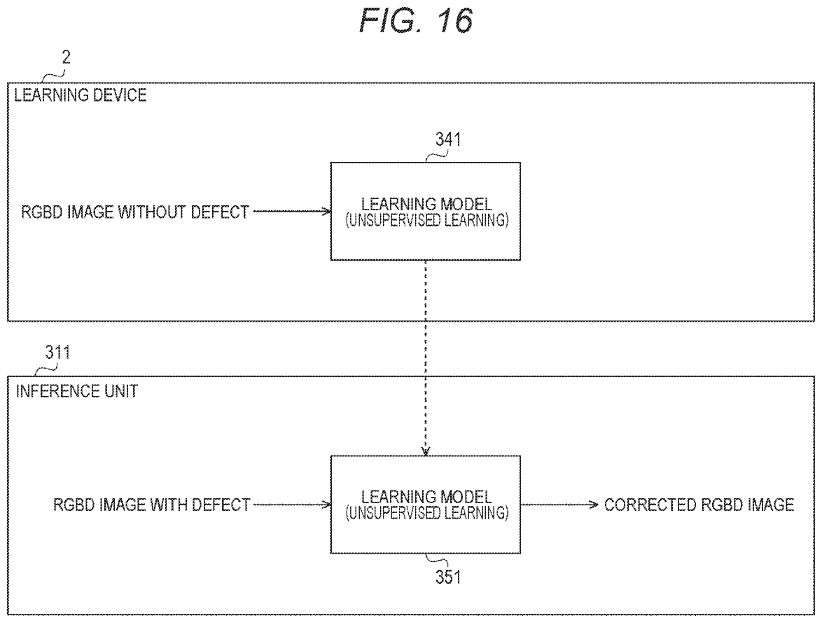

FIG. 16 illustrates a configuration example of a learning device that performs processing at the time of learning and an inference unit that performs processing at the time of inference in a case where unsupervised learning is used.

In FIG. 16, a learning device 2 that performs processing at the time of learning is illustrated in the upper part, and an inference unit 311 that performs processing at the time of inference is illustrated in the lower part. The inference unit 311 corresponds to the inference unit 311 in FIG. 13.

In FIG. 16, the learning device 2 includes a learning model 341. The learning model 341 is a model that performs machine learning by a neural network using an RGBD image without defect as an input. That is, since the learning model 341 repeats unsupervised learning by the neural network without knowing the defective RGBD image, the RGBD image in which the defect has disappeared is output as the output.

The learning model 341 subjected to unsupervised learning by machine learning at the time of learning in this manner can be used as a learned model at the time of inference.

In FIG. 16, the inference unit 311 includes a learning model 351. The learning model 351 corresponds to the learning model 341 that has been learned by performing unsupervised learning by machine learning at the time of learning.

The learning model 351 performs inference using the RGBD image having a defect in the depth value as an input, thereby outputting the RGBD image in which the defect has been corrected. Here, the RGBD image having a defect in the depth value is an RGBD image generated from the RGB image and the depth image serving as measurement data.

(Image Generation Process)

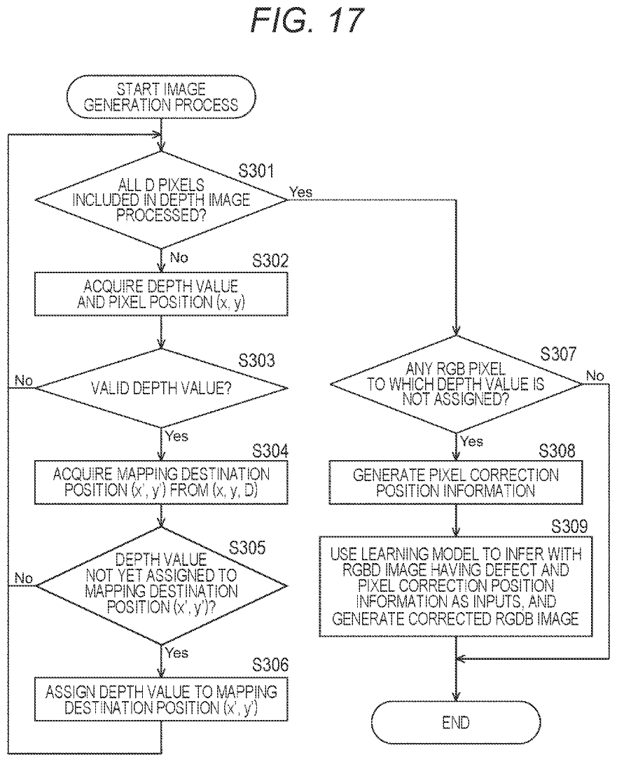

Next, a flow of a first example of image generation process by the image generation unit 301 will be described with reference to a flowchart of FIG. 17. In the first example, a flow of an image generation process in a case where an RGBD image is generated by mapping a depth image onto an image plane of an RGB image is illustrated.

In step S301, the image generation unit 301 determines whether or not all the D pixels included in the depth image have been processed. Here, pixels included in the depth image are referred to as the D pixels.

In a case where it is determined in step S301 that not all the D pixels have been processed, the process proceeds to step S302. In step S302, the image generation unit 301 acquires the depth value and the pixel position (x, y) of the D pixel to be processed.

In step S303, the image generation unit 301 determines whether or not the acquired depth value of the D pixel to be processed is a valid depth value.

In a case where it is determined that the depth value of the D pixel to be processed is a valid depth value in step S303, the process proceeds to step S304. In step S304, the image generation unit 301 acquires the mapping destination position (x′, y′) in the RGB image on the basis of the pixel position (x, y) and the depth value.

In step S305, the image generation unit 301 determines whether or not a depth value has not yet been assigned to the mapping destination position (x′, y′). Here, since a plurality of depth values may be assigned to one mapping destination position (x′, y′), in a case where the depth value has already been assigned to the mapping destination position (x′, y′), in step S305, whether or not the depth value to be assigned is smaller than the already assigned depth value is further determined.

In a case where it is determined that the depth value has not yet been assigned in step S305, or in a case where the depth value has already been assigned, if the depth value to be assigned is smaller than the already assigned depth value, the process proceeds to step S306. In step S306, the image generation unit 301 assigns a depth value to the mapping destination position (x′, y′).

When the process of step S306 ends, the process returns to step S301. Furthermore, in a case where it is determined that the depth value of the D pixel to be processed is not a valid depth value in step S303, or in a case where the depth value is already assigned in step S305 but the depth value to be assigned is larger than the already assigned depth value, the process returns to step S301.

With the D pixels included in the depth image sequentially being set as the D pixels to be processed, in a case where depth value of the pixel position (x, y) of the D pixel is valid and the depth value is not assigned to the corresponding mapping destination position (x′, y′), or in a case where the depth value is already assigned and the depth value to be assigned is smaller than the already assigned depth value, the depth value is assigned to the mapping destination position (x′, y′).

The above-described processes are repeated, and in a case where it is determined that all the D pixels have been processed in step S301, the process proceeds to step S307. That is, when all the D pixels are processed, mapping of the depth image onto the image plane of the RGB image is completed and an RGBD image is generated, but since there is a possibility that this RGBD image is a RGBD image having a defect (incomplete RGBD image), the processes of step S307 and subsequent steps are performed.

In step S307, the image generation unit 301 determines whether or not there is an RGB pixel to which a depth value is not assigned. Here, pixels included in the RGB image are referred to as the RGB pixels.

In a case where it is determined in step S307 that there is an RGB pixel to which a depth value is not assigned, the process proceeds to step S308.

In step S308, the image generation unit 301 generates the pixel correction position information on the basis of the information regarding the position of the RGB pixel to which the depth value is not assigned. With an RGB pixel to which a depth value is not assigned as a pixel (defective pixel) that needs to be corrected, the pixel correction position information includes information (e.g., coordinates of a defective pixel) that specifies the pixel position thereof.

In step S309, the inference unit 311 uses the learning model 331 (FIG. 15) to perform inference using the defective RGBD image and the pixel correction position information as inputs, and generates an RGBD image in which the defect is corrected. The learning model 331 is a learned model in which learning is performed by the neural network using the RGBD image having a defect in the depth value and the defective pixel position information as inputs at the time of learning, and can output the RGBD image in which the defect has been corrected. That is, in the RGBD image in which the defect has been corrected, the defect is corrected by inferring the depth value of the pixel correction position in the RGB image.

Note that, although the case of using the learning model 331 has been described here, another learned model such as the learning model 351 (FIG. 16) that performs inference using the RGBD image having a defect in the depth value as an input and outputs a RGBD image in which the defect is corrected may be used.

When the process of step S309 ends, a series of processes ends. Furthermore, in a case where it is determined that there is no RGB pixel to which a depth value is not assigned in step S307, an RGBD image (complete RGBD image) without a defect is generated and does not need to be corrected, and thus, the processes of steps S308 and S309 are skipped, and a series of processes ends.

The flow of the first example of the image generation process has been described above. In this image generation process, the following processes are performed when mapping the depth image acquired by the depth sensor 11 on the image plane of the RGB image acquired by the RGB sensor 12 to generate the RGBD image. That is, the position (x, y) is mapped on the image plane of the RGB image on the basis of the depth value of the pixel position (x, y) corresponding to each pixel of the depth image, a mapping destination position (x′, y′) to which the depth value of the pixel position (x, y) is not assigned among the mapping destination positions (x′, y′) corresponding to each pixel of the RGB image is specified as the pixel correction position, and the depth value of the pixel correction position in the RGB image is inferred using the learning model, thereby generating the corrected RGBD image.

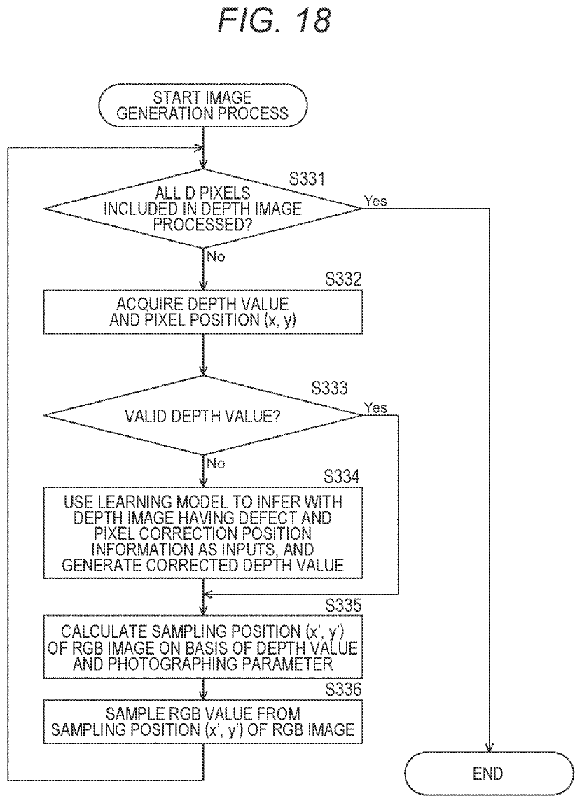

Next, a flow of a second example of image generation process by the image generation unit 301 will be described with reference to a flowchart of FIG. 18. In the second example, a flow of an image generation process in a case where an RGBD image is generated by mapping an RGB image to an image plane of the depth image is illustrated.

In step S331, the image generation unit 301 determines whether or not all the D pixels included in the depth image have been processed.

In a case where it is determined in step S331 that not all the D pixels have been processed, the process proceeds to step S332. In step S332, the image generation unit 301 acquires the depth value and the pixel position (x, y) of the D pixel to be processed.

In step S333, the image generation unit 301 determines whether or not the acquired depth value of the D pixel to be processed is a valid depth value.

In a case where it is determined in step S333 that the depth value of the D pixel to be processed is not a valid depth value, the processing proceeds to step S334.

In step S334, the inference unit 311 performs inference using the defective depth image and the pixel correction position information as inputs using the learning model, and generates a corrected depth value. The learning model used here is a learned model in which learning is performed by the neural network using the depth image having a defect in the depth value and the pixel correction position information as inputs at the time of learning, and the corrected depth value can be output. Note that a learned model learned by another neural network may be used as long as the corrected depth value can be generated.

When the process of step S334 is finished, the process proceeds to step S335. Furthermore, in a case where it is determined in step S333 that the depth value of the D pixel to be processed is a valid depth value, the process of step S334 is skipped, and the process proceeds to step S335.

In step S335, the image generation unit 301 calculates a sampling position (x′, y′) in the RGB image on the basis of the depth value and the photographing parameter. As the photographing parameter, for example, information associated with the relative position and posture between the depth sensor 11 and the RGB sensor 12 is used.

In step S336, the image generation unit 301 samples RGB values from sampling positions (x′, y′) of the RGB image.

When the process of step S336 is finished, the process returns to step S331, and the above-described processes are repeated. That is, with the D pixel included in the depth image being sequentially set as the D pixel to be processed, in a case where the depth value of the pixel position (x, y) of the D pixel is not valid, the sampling position (x′, y′) corresponding to the depth value of the D pixel to be processed is calculated by generating the corrected depth value using the learning model, and the RGB value is sampled from the RGB image.

In a case where the above-described process is repeated and it is determined in step S331 that all the D pixels have been processed, mapping of the RGB image to the image plane of the depth image is completed and the RGBD image is generated, and thus the series of processes are ended.

The flow of the second example of the image generation process has been described above. In this image generation process, the following processes are performed when mapping the RGB image acquired by the RGB sensor 12 on the image plane of the depth image acquired by the depth sensor 11 to generate the RGBD image. That is, among the pixel positions (x, y) corresponding to each pixel of the depth image, the pixel position (x, y) to which a valid depth value is not assigned is specified as the pixel correction position, the depth value of the pixel correction position in the depth image is inferred using the learning model, the RGB value is sampled from the sampling position (x′, y′) in the RGB image on the basis of the depth value assigned to the pixel position (x, y), and the sampling position (x′, y′) is mapped onto the image plane of the depth image, thereby generating the corrected RGBD image.

### Example of Use Case

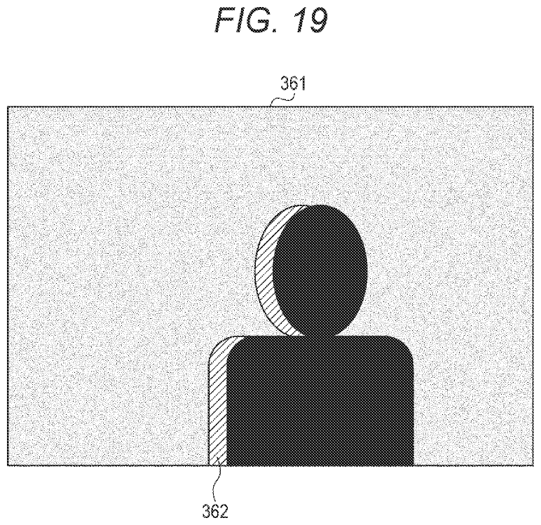

FIGS. 19 to 21 illustrate examples of use cases to which the present disclosure can be applied.

FIG. 19 is a diagram illustrating a first example of the use case. In FIG. 19, in a case where a shielded region 362 is included in the RGBD image 361 such as a portrait or a television conference in which a person is a subject, the depth value becomes difficult to obtain in the shielded region 362, and thus the shielded region 362 may be undesirably imaged in the background when removing the background while leaving the portion of the person.

In the technology according to the present disclosure, in the image generation unit 301 that generates an RGBD image, the inference unit 311 uses a learned model (learning model), uses an RGBD image having a defect in the depth value as an input and outputs the RGBD image in which the defect (portion of the shielded region 362) has been corrected, and thus such an event can be avoided.

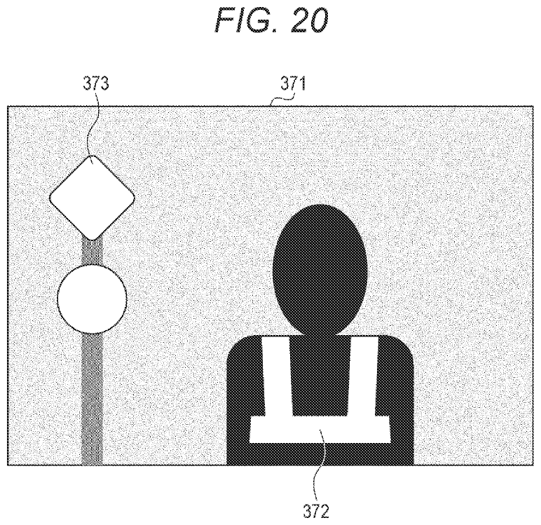

FIG. 20 is a diagram illustrating a second example of the use case. In FIG. 20, in a case where the RGBD image 371 obtained by sensing the worker at the construction site includes the reflective vest 372 worn by the worker, the reflective vest 372 includes a retroreflective material and strongly reflects light, and thus the light is saturated at the depth sensor 11 that emits light from the light source, and it is difficult to perform distance measurement. Furthermore, in a case where sensing is performed by an automatically driven vehicle, it is difficult for the depth sensor 11 to perform distance measurement even when a road sign 373 or the like including a retroreflective material having a strong reflectance is included in the RGBD image 371.

In the technology according to the present disclosure, in the image generation unit 301 that generates the RGBD image, the inference unit 311 uses the learned model, uses the RGBD image having a defect in the depth value as an input and outputs the RGBD image in which the defect (the portion of the reflective vest 372 or the road sign 373) has been corrected, and thus such an event can be avoided.

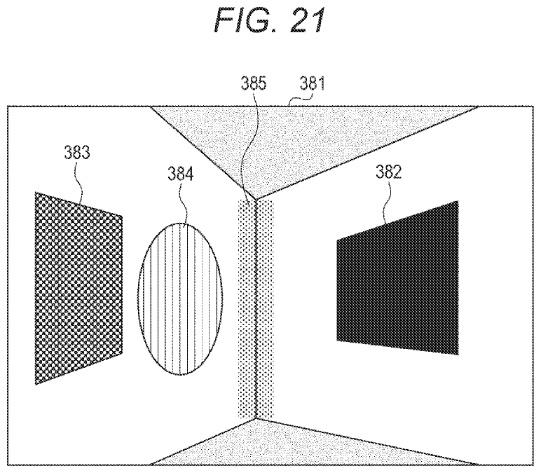

FIG. 21 is a diagram illustrating a third example of the use case. For example, in an application such as building measurement or a 3D augmented reality (AR) game, there is a case where it is desired to 3D scan the inside of a room. In FIG. 21, in a case where an RGBD image 381 obtained by sensing the inside of a room includes a transparent window 382, a high-frequency pattern 383, a mirror or a mirror surface 384, a wall corner 385, or the like, there is a possibility that a depth value cannot be obtained or a depth value is wrong.

In the technology according to the present disclosure, in the image generation unit 301 that generates an RGBD image, the inference unit 311 can use a learned model, use an RGBD image having a defect in the depth value, and output an RGBD image in which a defect (portions such as transparent window 382, high-frequency pattern 383, mirror or mirror surface 384, and wall corner 385) has been corrected. Therefore, in applications such as building measurement and 3D AR games, operations expected by those applications are performed by applying the technology according to the present disclosure to perform 3D scanning of a room.

### 4. Modifications

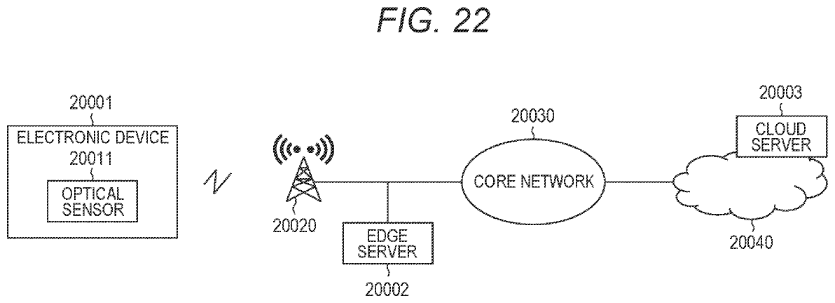

FIG. 22 illustrates a configuration example of a system including a device that performs AI processing.

An electronic device 20001 is a mobile terminal such as a smartphone, a tablet terminal, or a mobile phone. The electronic device 20001 corresponds to, for example, the information processing apparatus 1 in FIG. 1, and includes an optical sensor 20011 corresponding to the depth sensor 11 (FIG. 1). The optical sensor is a sensor (image sensor) that converts light into an electric signal. The electronic device 20001 can be connected to a network 20040 such as the Internet via a core network 20030 by being connected to a base station 20020 installed at a predetermined place by wireless communication corresponding to a predetermined communication method.

At a location closer to the mobile terminal, such as between the base station 20020 and the core network 20030, an edge server 20002 is provided to implement mobile edge computing (MEC). A cloud server 20003 is connected to the network 20040. The edge server 20002 and the cloud server 20003 can perform various types of processing according to the purpose. Note that the edge server 20002 may be provided in the core network 20030.

AI processing is performed by the electronic device 20001, the edge server 20002, the cloud server 20003, or the optical sensor 20011. The AI processing is processing the technology according to the present disclosure using AI such as machine learning. The AI processing includes learning processing and inference processing. The learning processing is processing of generating a learning model. Furthermore, the learning processing also includes relearning processing as described later. The inference processing is processing of performing inference using a learning model.

In the electronic device 20001, the edge server 20002, the cloud server 20003, or the optical sensor 20011, a processor such as a central processing unit (CPU) executes a program or dedicated hardware such as a processor specialized for a specific purpose is used to implement AI processing. For example, a graphics processing unit (GPU) can be used as a processor specialized for a specific purpose.

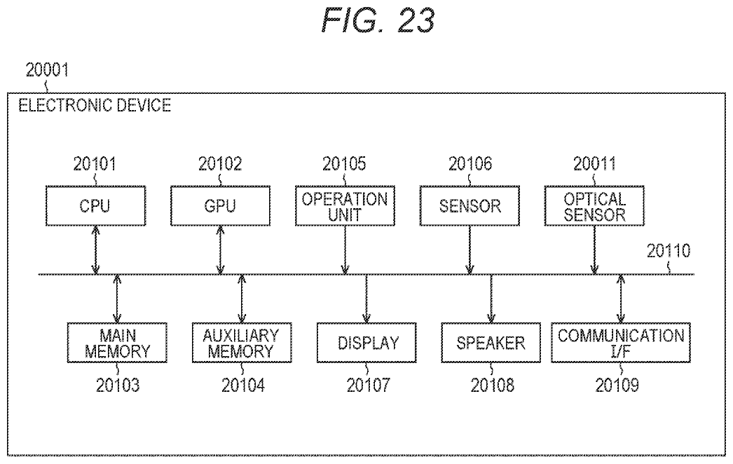

FIG. 23 illustrates a configuration example of the electronic device 20001. The electronic device 20001 includes a CPU 20101 that controls operation of each unit and performs various types of processing, a GPU 20102 specialized for image processing and parallel processing, a main memory 20103 such as a dynamic random access memory (DRAM), and an auxiliary memory 20104 such as a flash memory.

The auxiliary memory 20104 records programs for AI processing and data such as various parameters. The CPU 20101 loads the programs and parameters recorded in the auxiliary memory 20104 into the main memory 20103 and executes the programs. Alternatively, the CPU 20101 and the GPU 20102 develop programs and parameters recorded in the auxiliary memory 20104 in the main memory 20103 and execute the programs. Therefore, the GPU 20102 can be used as a general-purpose computing on graphics processing units (GPGPU).

Note that the CPU 20101 and the GPU 20102 may be configured as a system on a chip (SoC). In a case where the CPU 20101 executes programs for AI processing, the GPU 20102 may not be provided.

The electronic device 20001 also includes the optical sensor 20011 to which the technology according to the present disclosure is applied, an operation unit 20105 such as a physical button or a touch panel, a sensor 20106 including at least one or more sensors, a display 20107 that displays information such as an image or text, a speaker 20108 that outputs sound, a communication I/F 20109 such as a communication module compatible with a predetermined communication method, and a bus 20110 that connects them.

The sensor 20106 includes at least one of various sensors such as an optical sensor (image sensor), a sound sensor (microphone), a vibration sensor, an acceleration sensor, an angular velocity sensor, a pressure sensor, an odor sensor, or a biometric sensor. In the AI processing, data acquired from at least one or more sensors of the sensor 20106 can be used together with data (image data) acquired from the optical sensor 20011. That is, the optical sensor 20011 corresponds to the depth sensor 11 (FIG. 1), and the sensor 20106 corresponds to the RGB sensor 12 (FIG. 1).

Note that data acquired from two or more optical sensors by the sensor fusion technology and data obtained by integrally processing the data may be used in the AI processing. As the two or more optical sensors, a combination of the optical sensor 20011 and the optical sensor in the sensor 20106 may be used, or a plurality of optical sensors may be included in the optical sensor 20011. For example, the optical sensor includes an RGB visible light sensor, a distance measuring sensor such as time of flight (ToF), a polarization sensor, an event-based sensor, a sensor that acquires an IR image, a sensor capable of acquiring multiple wavelengths, and the like.

In the electronic device 20001, AI processing can be performed by a processor such as the CPU 20101 or the GPU 20102. In a case where the processor of the electronic device 20001 performs the inference processing, since the processing can be started without requiring time after the image data is acquired by the optical sensor 20011, the processing can be performed at high speed. Therefore, in the electronic device 20001, when the inference processing is used for a purpose such as an application required to transmit information with a short delay time, the user can perform an operation without feeling uncomfortable due to the delay. Furthermore, in a case where the processor of the electronic device 20001 performs AI processing, it is not necessary to use a communication line, a computer device for a server, or the like, and the processing can be implemented at low cost, as compared with a case where a server such as the cloud server 20003 is used.

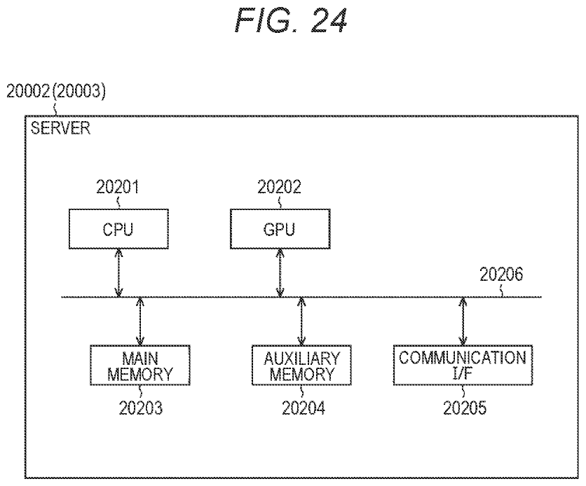

FIG. 24 illustrates a configuration example of the edge server 20002. The edge server 20002 includes a CPU 20201 that controls operation of each unit and performs various types of processing, and a GPU 20202 specialized for image processing and parallel processing. The edge server 20002 further includes a main memory 20203 such as a DRAM, an auxiliary memory 20204 such as a hard disk drive (HDD) or a solid state drive (SSD), and a communication I/F 20205 such as a network interface card (NIC), which are connected to the bus 20206.

The auxiliary memory 20204 records programs for AI processing and data such as various parameters. The CPU 20201 loads the programs and parameters recorded in the auxiliary memory 20204 into the main memory 20203 and executes the programs. Alternatively, the CPU 20201 and the GPU 20202 can develop programs or parameters recorded in the auxiliary memory 20204 in the main memory 20203 and execute the programs, whereby the GPU 20202 is used as a GPGPU. Note that, in a case where the CPU 20201 executes programs for AI processing, the GPU 20202 may not be provided.

In the edge server 20002, AI processing can be performed by a processor such as the CPU 20201 or the GPU 20202. In a case where the processor of the edge server 20002 performs the AI processing, since the edge server 20002 is provided at a position closer to the electronic device 20001 than the cloud server 20003, it is possible to realize low processing delay. Furthermore, the edge server 20002 has higher processing capability, such as a calculation speed, than the electronic device 20001 and the optical sensor 20011, and thus can be configured in a general-purpose manner. Therefore, in a case where the processor of the edge server 20002 performs the AI processing, the AI processing can be performed as long as data can be received regardless of a difference in specification or performance of the electronic device 20001 or the optical sensor 20011. In a case where the AI processing is performed by the edge server 20002, a processing load in the electronic device 20001 and the optical sensor 20011 can be reduced.

Since the configuration of the cloud server 20003 is similar to the configuration of the edge server 20002, the description thereof will be omitted.

In the cloud server 20003, AI processing can be performed by a processor such as the CPU 20201 or the GPU 20202. The cloud server 20003 has higher processing capability, such as calculation speed, than the electronic device 20001 and the optical sensor 20011, and thus can be configured in a general-purpose manner. Therefore, in a case where the processor of the cloud server 20003 performs the AI processing, the AI processing can be performed regardless of a difference in specifications and performance of the electronic device 20001 and the optical sensor 20011. Furthermore, in a case where it is difficult for the processor of the electronic device 20001 or the optical sensor 20011 to perform high-load AI processing, the processor of the cloud server 20003 can perform the high-load AI processing, and the processing result can be fed back to the processor of the electronic device 20001 or the optical sensor 20011.

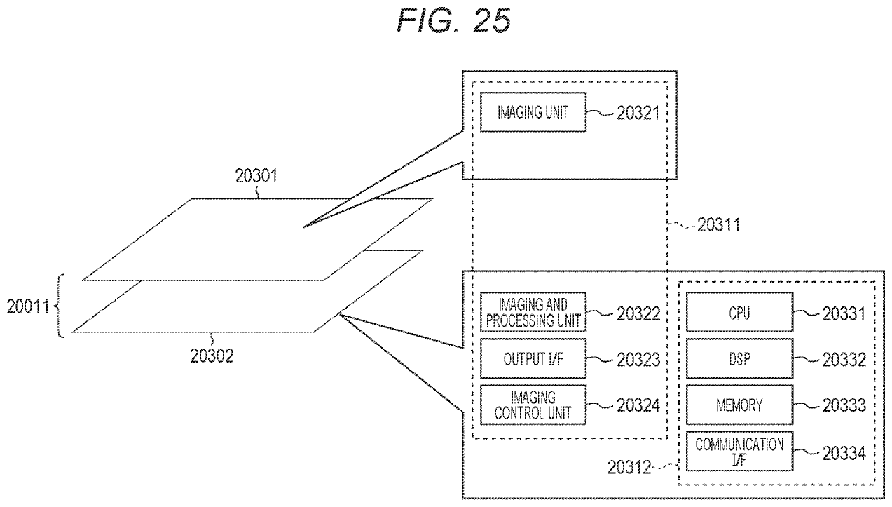

FIG. 25 illustrates a configuration example of the optical sensor 20011. The optical sensor 20011 can be configured as, for example, a one-chip semiconductor device having a stacked structure in which a plurality of substrates is stacked. The optical sensor 20011 is configured by stacking two substrates of a substrate 20301 and a substrate 20302. Note that the configuration of the optical sensor 20011 is not limited to the stacked structure, and for example, a substrate including an imaging unit may include a processor that performs AI processing such as a CPU or a digital signal processor (DSP).

An imaging unit 20321 including a plurality of pixels two-dimensionally arranged is mounted on the upper substrate 20301. An imaging processing unit 20322 that performs processing related to imaging of an image by the imaging unit 20321, an output I/F 20323 that outputs a captured image and a signal processing result to the outside, and an imaging control unit 20324 that controls imaging of an image by the imaging unit 20321 are mounted on the lower substrate 20302. The imaging unit 20321, the imaging processing unit 20322, the output I/F 20323, and the imaging control unit 20324 constitute an imaging block 20311.

A CPU 20331 that performs control of each unit and various types of processing, a DSP 20332 that performs signal processing using a captured image, information from the outside, and the like, a memory 20333 such as a static random access memory (SRAM) or a dynamic random access memory (DRAM), and a communication I/F 20334 that exchanges necessary information with the outside are mounted on the lower substrate 20302. The CPU 20331, the DSP 20332, the memory 20333, and the communication I/F 20334 constitute a signal processing block 20312. AI processing can be performed by at least one processor of the CPU 20331 or the DSP 20332.

As described above, the signal processing block 20312 for AI processing can be mounted on the lower substrate 20302 in the stacked structure in which the plurality of substrates is stacked. Therefore, the image data acquired by the imaging block 20311 for imaging mounted on the upper substrate 20301 is processed by the signal processing block 20312 for AI processing mounted on the lower substrate 20302, so that a series of processing can be performed in the one-chip semiconductor device.

In the optical sensor 20011, AI processing can be performed by a processor such as the CPU 20331. In a case where the processor of the optical sensor 20011 performs AI processing such as inference processing, since a series of processing is performed in a one-chip semiconductor device, information does not leak to the outside of the sensor, and thus, it is possible to enhance confidentiality of the information. Furthermore, since it is not necessary to transmit data such as image data to another device, the processor of the optical sensor 20011 can perform AI processing such as inference processing using the image data at high speed. For example, when inference processing is used for a purpose such as an application requiring a real-time property, it is possible to sufficiently secure the real-time property. Here, securing the real-time property means that information can be transmitted with a short delay time. Moreover, when the processor of the optical sensor 20011 performs the AI processing, various kinds of metadata are passed by the processor of the electronic device 20001, so that the processing can be reduced and the power consumption can be reduced.

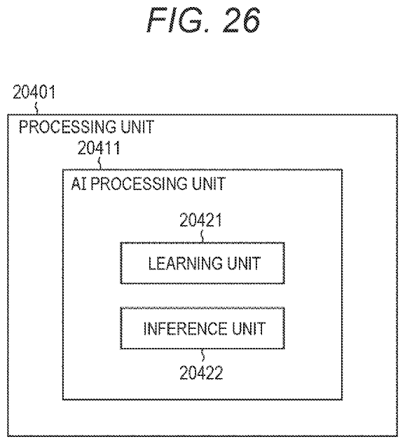

FIG. 26 illustrates a configuration example of a processing unit 20401. The processing unit 20401 corresponds to the processing unit 10 in FIG. 1. A processor of the electronic device 20001, the edge server 20002, the cloud server 20003, or the optical sensor 20011 executes various types of processing according to a program, thereby functioning as the processing unit 20401. Note that a plurality of processors included in the same or different devices may function as the processing unit 20401.

The processing unit 20401 includes an AI processing unit 20411. The AI processing unit 20411 performs AI processing. The AI processing unit 20411 includes a learning unit 20421 and an inference unit 20422.

The learning unit 20421 performs learning processing of generating a learning model. In the learning processing, a machine-learned learning model that has been subjected to machine learning for correcting a correction target pixel included in image data is generated. Furthermore, the learning unit 20421 may perform relearning processing of updating the generated learning model. In the following description, generation and update of the learning model will be described separately, but since it can be said that the learning model is generated by updating the learning model, the generation of the learning model includes the meaning of the update of the learning model.

Furthermore, the generated learning model is recorded in a storage medium such as a main memory or an auxiliary memory included in the electronic device 20001, the edge server 20002, the cloud server 20003, the optical sensor 20011, or the like, and thus, can be newly used in the inference processing performed by the inference unit 20422. Therefore, the electronic device 20001, the edge server 20002, the cloud server 20003, the optical sensor 20011, or the like that performs inference processing on the basis of the learning model can be generated. Moreover, the generated learning model may be recorded in a storage medium or electronic device independent of the electronic device 20001, the edge server 20002, the cloud server 20003, the optical sensor 20011, or the like, and provided for use in other devices. Note that the generation of the electronic device 20001, the edge server 20002, the cloud server 20003, the optical sensor 20011, or the like includes not only newly recording the learning model in the storage medium at the time of manufacturing but also updating the already recorded generated learning model.

The inference unit 20422 performs inference processing using the learning model. In the inference processing, processing of identifying a correction target pixel included in image data or correcting the identified correction target pixel is performed using the learning model. The correction target pixel is a pixel to be corrected that satisfies a predetermined condition among a plurality of pixels in an image according to the image data.

As a technique of machine learning, a neural network, deep learning, or the like can be used. The neural network is a model imitating a human cranial nerve circuit, and includes three types of layers of an input layer, an intermediate layer (hidden layer), and an output layer. Deep learning is a model using a neural network having a multilayer structure, and can learn a complex pattern hidden in a large amount of data by repeating characteristic learning in each layer.

Supervised learning can be used as the problem setting of the machine learning. For example, in the supervised learning, a feature amount is learned on the basis of given labeled supervised data. Therefore, it is possible to derive a label of unknown data. As the learning data, image data actually acquired by the optical sensor, acquired image data aggregated and managed, a data set generated by the simulator, and the like can be used.

Note that not only supervised learning but also unsupervised learning, semi-supervised learning, reinforcement learning, and the like may be used. In the unsupervised learning, a large amount of unlabeled learning data is analyzed to extract a feature amount, and clustering or the like is performed on the basis of the extracted feature amount. Therefore, it is possible to analyze and predict the tendency on the basis of a huge amount of unknown data. The semi-supervised learning is a method in which supervised learning and unsupervised learning are mixed, and is a method in which a feature amount is trained by the supervised learning, then a huge amount of learning data is given by the unsupervised learning, and repetitive learning is performed while the feature amount is automatically calculated. The reinforcement learning deals with a problem of determining an action that an agent in a certain environment should take by observing a current state.

As described above, the processor of the electronic device 20001, the edge server 20002, the cloud server 20003, or the optical sensor 20011 functions as the AI processing unit 20411, so that the AI processing is performed by any one or a plurality of devices.

The AI processing unit 20411 only needs to include at least one of the learning unit 20421 or the inference unit 20422. That is, the processor of each device may execute one of the learning processing or the inference processing as well as execute both the learning processing and the inference processing. For example, in a case where the processor of the electronic device 20001 performs both the inference processing and the learning processing, the learning unit 20421 and the inference unit 20422 are included, but in a case where only the inference processing is performed, only the inference unit 20422 is required to be included.

The processor of each device may execute all processes related to the learning processing or the inference processing, or may execute some processes by the processor of each device and then execute the remaining processes by the processor of another device. Furthermore, each device may have a common processor for executing each function of AI processing such as learning processing or inference processing, or may have a processor individually for each function.

Note that the AI processing may be performed by a device other than the above-described devices. For example, AI processing can be performed by another electronic device to which the electronic device 20001 can be connected by wireless communication or the like. Specifically, in a case where the electronic device 20001 is a smartphone, the other electronic device that performs the AI processing can be a device such as another smartphone, a tablet terminal, a mobile phone, a personal computer (PC), a game machine, a television receiver, a wearable terminal, a digital still camera, or a digital video camera.

Furthermore, even in a configuration using a sensor mounted on a moving body such as an automobile, a sensor used in a remote medical device, or the like, AI processing such as inference processing can be applied, but a delay time is required to be short in these environments. In such an environment, the delay time can be shortened by not performing the AI processing by the processor of the cloud server 20003 via the network 20040 but performing the AI processing by the processor of the local-side device (for example, the electronic device 20001 as the in-vehicle device or the medical device). Moreover, even in a case where there is no environment to connect to the network 20040 such as the Internet or in a case of a device used in an environment in which high-speed connection cannot be performed, AI processing can be performed in a more appropriate environment by performing AI processing by the processor of the local-side device such as the electronic device 20001 or the optical sensor 20011, for example.

Note that the above-described configuration is an example, and other configurations may be adopted. For example, the electronic device 20001 is not limited to a mobile terminal such as a smartphone, and may be an electronic device such as a PC, a game machine, a television receiver, a wearable terminal, a digital still camera, or a digital video camera, an in-vehicle device, or a medical device. Furthermore, the electronic device 20001 may be connected to the network 20040 by wireless communication or wired communication corresponding to a predetermined communication method such as a wireless local area network (LAN) or a wired LAN. The AI processing is not limited to a processor such as a CPU or a GPU of each device, and a quantum computer, a neuromorphic computer, or the like may be used.

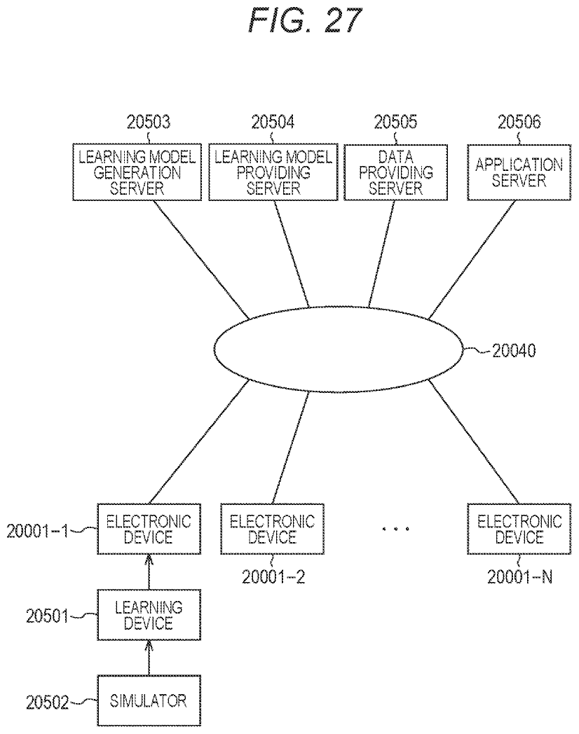

Incidentally, the data such as the learning model, the image data, and the corrected data may be used in a single device or may be exchanged between a plurality of devices and used in those devices. FIG. 27 illustrates a flow of data between a plurality of devices.

Electronic devices 20001-1 to 20001-N (N is an integer of 1 or more) are possessed by each user, for example, and can be connected to the network 20040 such as the Internet via a base station (not illustrated) or the like. At the time of manufacturing, a learning device 20501 is connected to the electronic device 20001-1, and the learning model provided by the learning device 20501 can be recorded in the auxiliary memory 20104. The learning device 20501 generates a learning model by using a data set generated by a simulator 20502 as learning data and provides the learning model to the electronic device 20001-1. Note that the learning data is not limited to the data set provided from the simulator 20502, and image data actually acquired by the optical sensor, acquired image data aggregated and managed, or the like may be used.

Although not illustrated, the learning model can be recorded in the electronic devices 20001-2 to 20001-N at the stage of manufacturing, similarly to the electronic device 20001-1. Hereinafter, the electronic devices 20001-1 to 20001-N will be referred to as electronic devices 20001 in a case where it is not necessary to distinguish the electronic devices from each other.

In addition to the electronic device 20001, a learning model generation server 20503, a learning model providing server 20504, a data providing server 20505, and an application server 20506 are connected to the network 20040, and can exchange data with each other. Each server can be provided as a cloud server.

The learning model generation server 20503 has a configuration similar to that of the cloud server 20003, and can perform learning processing by a processor such as a CPU. The learning model generation server 20503 generates a learning model using the learning data. In the illustrated configuration, the case where the electronic device 20001 records the learning model at the time of manufacturing is exemplified, but the learning model may be provided from the learning model generation server 20503. The learning model generation server 20503 transmits the generated learning model to the electronic device 20001 via the network 20040. The electronic device 20001 receives the learning model transmitted from the learning model generation server 20503 and records the learning model in the auxiliary memory 20104. Therefore, the electronic device 20001 including the learning model is generated.

That is, in the electronic device 20001, in a case where the learning model is not recorded at the stage of manufacturing, the electronic device 20001 recording the new learning model is generated by newly recording the learning model from the learning model generation server 20503. Furthermore, in the electronic device 20001, in a case where the learning model has already been recorded at the stage of manufacturing, the electronic device 20001 recording the updated learning model is generated by updating the recorded learning model to the learning model from the learning model generation server 20503. The electronic device 20001 can perform inference processing using a learning model that is appropriately updated.

The learning model is not limited to being directly provided from the learning model generation server 20503 to the electronic device 20001, and may be provided by the learning model providing server 20504 that aggregates and manages various learning models via the network 20040. The learning model providing server 20504 may generate another device including a learning model by providing the learning model to the other device, not limited to the electronic device 20001. Furthermore, the learning model may be provided by being recorded in a detachable memory card such as a flash memory. The electronic device 20001 can read and record the learning model from the memory card attached to the slot. Therefore, the electronic device 20001 can acquire the learning model even in a case where the electronic device is used in a severe environment, in a case where the electronic device does not have a communication function, in a case where the electronic device has a communication function but the amount of information that can be transmitted is small, or the like.

The electronic device 20001 can provide data such as image data, corrected data, and metadata to other devices via the network 20040. For example, the electronic device 20001 transmits data such as image data and corrected data to the learning model generation server 20503 via the network 20040. Therefore, the learning model generation server 20503 can generate a learning model using data such as image data or corrected data collected from one or a plurality of electronic devices 20001 as learning data. By using more learning data, the accuracy of the learning processing can be improved.

The data such as the image data and the corrected data is not limited to be directly provided from the electronic device 20001 to the learning model generation server 20503, and may be provided by the data providing server 20505 that aggregates and manages various data. The data providing server 20505 may collect data from not only the electronic device 20001 but also another device, or may provide data to not only the learning model generation server 20503 but also another device.

The learning model generation server 20503 may perform relearning processing of adding data such as image data and corrected data provided from the electronic device 20001 or the data providing server 20505 to the learning data on the already-generated learning model to update the learning model. The updated learning model can be provided to the electronic device 20001. In a case where learning processing or relearning processing is performed in the learning model generation server 20503, processing can be performed regardless of a difference in specification or performance of the electronic device 20001.

Furthermore, in the electronic device 20001, in a case where the user performs a correction operation on the corrected data or the metadata (for example, in a case where the user inputs correct information), the feedback data regarding the correction processing may be used for the relearning processing. For example, by transmitting the feedback data from the electronic device 20001 to the learning model generation server 20503, the learning model generation server 20503 can perform relearning processing using the feedback data from the electronic device 20001 and update the learning model. Note that, in the electronic device 20001, an application provided by the application server 20506 may be used when the user performs a correction operation.

The relearning processing may be performed by the electronic device 20001. In a case where the electronic device 20001 updates the learning model by performing the relearning processing using the image data or the feedback data, the learning model can be improved in the device. Therefore, the electronic device 20001 including the updated learning model is generated. Furthermore, the electronic device 20001 may transmit the learning model after update obtained by the relearning processing to the learning model providing server 20504 so as to be provided to another electronic device 20001. Therefore, the learning model after the update can be shared among the plurality of electronic devices 20001.

Alternatively, the electronic device 20001 may transmit difference information of the relearning learning model (difference information regarding the learning model before update and the learning model after update) to the learning model generation server 20503 as update information. The learning model generation server 20503 can generate an improved learning model on the basis of the update information from the electronic device 20001 and provide the improved learning model to another electronic device 20001. By exchanging such difference information, privacy can be protected and communication cost can be reduced as compared with a case where all information is exchanged. Note that, similarly to the electronic device 20001, the optical sensor 20011 mounted on the electronic device 20001 may perform the relearning processing.

The application server 20506 is a server capable of providing various applications via the network 20040. An application provides a predetermined function using data such as a learning model, corrected data, or metadata. The electronic device 20001 can implement a predetermined function by executing an application downloaded from the application server 20506 via the network 20040. Alternatively, the application server 20506 can also implement a predetermined function by acquiring data from the electronic device 20001 via, for example, an application programming interface (API) or the like and executing an application on the application server 20506.

As described above, in a system including a device to which the present technology is applied, data such as a learning model, image data, and corrected data is exchanged and distributed among the devices, and various services using the data can be provided. For example, it is possible to provide a service for providing a learning model via the learning model providing server 20504 and a service for providing data such as image data and corrected data via the data providing server 20505. Furthermore, it is possible to provide a service for providing an application via the application server 20506.

Alternatively, the image data acquired from the optical sensor 20011 of the electronic device 20001 may be input to the learning model provided by the learning model providing server 20504, and corrected data obtained as an output thereof may be provided. Furthermore, a device such as an electronic device on which the learning model provided by the learning model providing server 20504 is equipped may be generated and provided. Moreover, by recording data such as the learning model, the corrected data, and the metadata in a readable storage medium, a device such as a storage medium in which the data is recorded or an electronic device on which the storage medium is mounted may be generated and provided. The storage medium may be a nonvolatile memory such as a magnetic disk, an optical disk, a magneto-optical disk, or a semiconductor memory, or may be a volatile memory such as an SRAM or a DRAM.

Note that an embodiment of the present disclosure is not limited to the foregoing embodiment, and various modifications are possible without departing from the scope of the present disclosure. Furthermore, the effects described herein are merely examples and are not limited, and other effects may be provided.

Furthermore, the present disclosure can have the following configurations.

(1)

An information processing apparatus including
a processing unit
that performs processing using a learned model learned by machine learning on at least a part of a first image in which an object acquired by a first sensor is indicated by depth information, a second image in which an image of the object acquired by a second sensor is indicated by plane information, and a third image obtained from the first image and the second image to specify a correction target pixel included in the first image.

(2)

The information processing apparatus described in (1), in which
the learned model is a deep neural network in which the first image and the second image are inputs and a first region including a correction target pixel designated for the first image is learned as teacher data.

(3)

The information processing apparatus described in (1) or (2), in which
the learned model outputs a binary classification image by semantic segmentation or coordinate information by an object detection algorithm as a second region including the specified correction target pixel.

(4)

The information processing apparatus described in (2) or (3), in which
the first image is converted into a viewpoint of the second sensor and processed.

(5)

The information processing apparatus described in (1), in which
the learned model is an autoencoder that has performed unsupervised learning with the first image and the second image without a defect as inputs, and
the processing unit is configured to,
compare the first image having a possibility of a defect with the first image output from the learned model; and
specify the correction target pixel on the basis of a comparison result.

(6)

The information processing apparatus described in (5), in which
the processing unit is configured to,
calculate a ratio of distance values of respective pixels of the two first images to be compared; and
specify a pixel in which the calculated ratio is greater than or equal to a predetermined threshold value as the correction target pixel.

(7)

The information processing apparatus described in (5) or (6), in which
the first image is converted into a viewpoint of the second sensor and processed.

(8)

An information processing method in which
an information processing apparatus performs processing using a learned model learned by machine learning on at least a part of a first image in which an object acquired by a first sensor is indicated by depth information, a second image in which an image of the object acquired by a second sensor is indicated by plane information, and a third image obtained from the first image and the second image to specify a correction target pixel included in the first image.

(9)

A program for causing a computer to function as an information processing apparatus including a processing unit,
the processing unit being configured to perform processing using a learned model learned by machine learning on at least a part of a first image in which an object acquired by a first sensor is indicated by depth information, a second image in which an image of the object acquired by a second sensor is indicated by plane information, and a third image obtained from the first image and the second image to specify a correction target pixel included in the first image.

(10)

An information processing apparatus including a processing unit configured to,
acquire a first image in which an object acquired by a first sensor is indicated by depth information and a second image in which an image of the object acquired by a second sensor is indicated by plane information;
generate the first image in a pseudo manner as a third image on the basis of the second image paired with the first image;
compare the first image with the third image; and
specify a correction target pixel included in the first image on the basis of a comparison result.

(11)

The information processing apparatus described in (10), in which
the processing unit uses GAN to generate the third image from the second image.

(12)

The information processing apparatus described in (11), in which
the processing unit uses a learned model obtained by learning a correspondence relationship of the second image paired with the first image by the GAN.

(13)

The information processing apparatus described in any one of (10) to (12), in which
the processing unit is configured to,
generate a fourth image obtained by converting the first image into a viewpoint of the second sensor on the basis of a photographing parameter; and
compare the fourth image with the third image.

(14)

The information processing apparatus described in any one of (10) to (13), in which
the processing unit compares the first image and the third image by taking a difference or a ratio of luminance for each corresponding pixel.

(15)

The information processing apparatus described in (14), in which
the processing unit is configured to,
set a predetermined threshold value; and
specify, as the correction target pixel, a pixel in which an absolute value of a difference or a ratio of luminance for each pixel is greater than or equal to the threshold value.

(16)

The information processing apparatus described in any one of (10) to (15), in which
the processing unit is configured to correct the correction target pixel by replacing luminance of a peripheral region including the correction target pixel in the first image.

(17)

The information processing apparatus described in (16), in which
the processing unit is configured to calculate a statistic of luminance values of pixels excluding the correction target pixel among pixels included in the peripheral region and replace the calculated statistic with the luminance value of the peripheral region, or replace the luminance value of the peripheral region with a luminance value of a region corresponding to the peripheral region in the third image.

(18)

An information processing method in which
an information processing apparatus is configured to,
acquire a first image in which an object acquired by a first sensor is indicated by depth information and a second image in which an image of the object acquired by a second sensor is indicated by plane information;
generate the first image in a pseudo manner as a third image on the basis of the second image paired with the first image;
compare the first image with the third image; and
specify a correction target pixel included in the first image on the basis of a comparison result.

(19)

A program for causing a computer to function as an information processing apparatus including a processing unit configured to,
acquire a first image in which an object acquired by a first sensor is indicated by depth information and a second image in which an image of the object acquired by a second sensor is indicated by plane information;
generate the first image in a pseudo manner as a third image on the basis of the second image paired with the first image;
compare the first image with the third image; and
specify a correction target pixel included in the first image on the basis of a comparison result.

(20)

An information processing apparatus including
a processing unit that generates a third image by mapping a first image in which an object acquired by a first sensor is indicated by depth information onto an image plane of a second image in which an image of the object acquired by a second sensor is indicated by color information, where
the processing unit is configured to,
map a first position on an image plane of the second image on the basis of depth information of the first position corresponding to each pixel of the first image,
specify, as a pixel correction position, a second position to which depth information of the first position is not assigned among second positions corresponding to respective pixels of the second image, and
infer depth information of the pixel correction position in the second image by using a learned model learned by machine learning.

(21)

The information processing apparatus described in (20), in which
the learned model is a neural network configured to output the corrected third image by learning using the third image having a defect in depth information and the pixel correction position as inputs.

(22)

The information processing apparatus described in (20), in which
the learned model is a neural network configured to output the corrected third image by unsupervised learning using the third image without defect as an input.

(23)

An information processing method in which
an information processing apparatus is configured to,
when generating a third image by mapping a first image in which an object acquired by a first sensor is indicated by depth information onto an image plane of a second image in which an image of the object acquired by a second sensor is indicated by color information,
map a first position on an image plane of the second image on the basis of depth information of the first position corresponding to each pixel of the first image,
specify, as a pixel correction position, a second position to which depth information of the first position is not assigned among second positions corresponding to respective pixels of the second image, and
infer depth information of the pixel correction position in the second image using a learned model learned by machine learning.

(24)

A program for causing a computer to function as an information processing apparatus including a processing unit that generates a third image by mapping a first image in which an object acquired by a first sensor is indicated by depth information onto an image plane of a second image in which an image of the object acquired by a second sensor is indicated by color information, where
the processing unit is configured to,
map a first position on an image plane of the second image on the basis of depth information of the first position corresponding to each pixel of the first image,
specify, as a pixel correction position, a second position to which depth information of the first position is not assigned among second positions corresponding to respective pixels of the second image, and
infer depth information of the pixel correction position in the second image using a learned model learned by machine learning.

(25)

A program for causing a computer to function as an information processing apparatus including a processing unit that generates a third image by mapping a second image in which an image of an object acquired by a second sensor is indicated by color information onto an image plane of a first image in which the object acquired by a first sensor is indicated by depth information, where
the processing unit is configured to,
specify, as a pixel correction position, a first position to which valid depth information is not assigned among first positions corresponding to respective pixels of the first image,
infer depth information of the pixel correction position in the first image using a learned model learned by machine learning, and
sample color information from a second position in the second image on the basis of depth information assigned to the first position to map the second position to the image plane of the first image.

(26)

The information processing apparatus described in (25),
where the learned model is a neural network configured to output the corrected depth information by learning using the first image having a defect and the pixel correction position as inputs.

(27)

An information processing method in which
an information processing apparatus is configured to,
when generating a third image by mapping a second image in which an image of an object acquired by a second sensor is indicated by color information onto an image plane of a first image in which the object acquired by a first sensor is indicated by depth information,
specify, as a pixel correction position, a first position to which valid depth information is not assigned among first positions corresponding to respective pixels of the first image,
infer depth information of the pixel correction position in the first image using a learned model learned by machine learning, and
sample color information from a second position in the second image on the basis of depth information assigned to the first position to map the second position to the image plane of the first image.

(28)
A program for causing a computer to function as an information processing apparatus including a processing unit that generates a third image by mapping a second image in which an image of an object acquired by a second sensor is indicated by color information onto an image plane of a first image in which the object acquired by a first sensor is indicated by depth information, where
the processing unit is configured to,
specify, as a pixel correction position, a first position to which valid depth information is not assigned among first positions corresponding to respective pixels of the first image,
infer depth information of the pixel correction position in the first image using a learned model learned by machine learning, and
sample color information from a second position in the second image on the basis of depth information assigned to the first position to map the second position to the image plane of the first image.

### REFERENCE SIGNS LIST

1 Information processing apparatus
2 Learning device
10 Processing unit
11 Depth sensor
12 RGB sensor
13 Depth processing unit
14 RGB processing unit
111 Viewpoint conversion unit
112 Defect region designating unit
113 Learning model
114 Subtraction unit
121 Viewpoint conversion unit
122 Learning model
131 Viewpoint conversion unit
132 Learning model
133 Subtraction unit
141 Viewpoint conversion unit
142 Learning model
143 Comparing unit
201 Specifying unit
202 Correction unit
211 Learning model
212 Viewpoint conversion unit
213 Comparing unit
301 Image generation unit
311 Inference unit
321 Learning model
331 Learning model
341 Learning model
351 Learning model

1. An information processing apparatus comprising
a processing unit
that performs processing using a learned model learned by machine learning on at least a part of a first image in which an object acquired by a first sensor is indicated by depth information, a second image in which an image of the object acquired by a second sensor is indicated by plane information, and a third image obtained from the first image and the second image to specify a correction target pixel included in the first image.

2. The information processing apparatus according to claim 1, wherein
the learned model is a deep neural network in which the first image and the second image are inputs and a first region including a correction target pixel designated for the first image is learned as teacher data.

3. The information processing apparatus according to claim 2, wherein
the learned model outputs a binary classification image by semantic segmentation or coordinate information by an object detection algorithm as a second region including the specified correction target pixel.

4. The information processing apparatus according to claim 2, wherein
the first image is converted into a viewpoint of the second sensor and processed.

5. The information processing apparatus according to claim 1, wherein
the learned model is an autoencoder that has performed unsupervised learning with the first image and the second image without a defect as inputs, and
the processing unit is configured to,
compare the first image having a possibility of a defect with the first image output from the learned model; and
specify the correction target pixel on a basis of a comparison result.

6. The information processing apparatus according to claim 5, wherein
the processing unit is configured to,
calculate a ratio of distance values of respective pixels of the two first images to be compared; and
specify a pixel in which the calculated ratio is greater than or equal to a predetermined threshold value as the correction target pixel.

7. The information processing apparatus according to claim 5, wherein
the first image is converted into a viewpoint of the second sensor and processed.

8. An information processing method in which
an information processing apparatus performs processing using a learned model learned by machine learning on at least a part of a first image in which an object acquired by a first sensor is indicated by depth information, a second image in which an image of the object acquired by a second sensor is indicated by plane information, and a third image obtained from the first image and the second image to specify a correction target pixel included in the first image.

9. A program for causing a computer to function as an information processing apparatus comprising
a processing unit, the processing unit performing processing using a learned model learned by machine learning on at least a part of a first image in which an object acquired by a first sensor is indicated by depth information, a second image in which an image of the object acquired by a second sensor is indicated by plane information, and a third image obtained from the first image and the second image to specify a correction target pixel included in the first image.

10. An information processing apparatus comprising a processing unit configured to,
acquire a first image in which an object acquired by a first sensor is indicated by depth information and a second image in which an image of the object acquired by a second sensor is indicated by plane information;
generate the first image in a pseudo manner as a third image on a basis of the second image paired with the first image;
compare the first image with the third image; and
specify a correction target pixel included in the first image on a basis of a comparison result.

11. The information processing apparatus according to claim 10, wherein
the processing unit uses GAN to generate the third image from the second image.

12. The information processing apparatus according to claim 11, wherein
the processing unit uses a learned model obtained by learning a correspondence relationship of the second image paired with the first image by the GAN.

13. The information processing apparatus according to claim 10, wherein
the processing unit is configured to,
generate a fourth image obtained by converting the first image into a viewpoint of the second sensor on a basis of a photographing parameter; and
compare the fourth image with the third image.

14. The information processing apparatus according to claim 10, wherein
the processing unit compares the first image and the third image by taking a difference or a ratio of luminance for each corresponding pixel.

15. The information processing apparatus according to claim 14, wherein
the processing unit is configured to,
set a predetermined threshold value; and
specify, as the correction target pixel, a pixel in which an absolute value of a difference or a ratio of luminance for each pixel is greater than or equal to the threshold value.

16. The information processing apparatus according to claim 10, wherein
the processing unit is configured to correct the correction target pixel by replacing luminance of a peripheral region including the correction target pixel in the first image.

17. The information processing apparatus according to claim 16, wherein
the processing unit is configured to calculate a statistic of luminance values of pixels excluding the correction target pixel among pixels included in the peripheral region and replace the calculated statistic with the luminance value of the peripheral region, or replace the luminance value of the peripheral region with a luminance value of a region corresponding to the peripheral region in the third image.

18. An information processing method in which an information processing apparatus is configured to,
acquire a first image in which an object acquired by a first sensor is indicated by depth information and a second image in which an image of the object acquired by a second sensor is indicated by plane information;
generate the first image in a pseudo manner as a third image on a basis of the second image paired with the first image;
compare the first image with the third image; and
specify a correction target pixel included in the first image on a basis of a comparison result.

19. A program for causing a computer to function as an information processing apparatus including a processing unit configured to,
acquire a first image in which an object acquired by a first sensor is indicated by depth information and a second image in which an image of the object acquired by a second sensor is indicated by plane information;
generate the first image in a pseudo manner as a third image on a basis of the second image paired with the first image;
compare the first image with the third image; and
specify a correction target pixel included in the first image on a basis of a comparison result.

20. An information processing apparatus including a processing unit that generates a third image by mapping a first image in which an object acquired by a first sensor is indicated by depth information onto an image plane of a second image in which an image of the object acquired by a second sensor is indicated by color information, wherein
the processing unit is configured to,
map a first position on an image plane of the second image on a basis of depth information of the first position corresponding to each pixel of the first image,
specify, as a pixel correction position, a second position to which depth information of the first position is not assigned among second positions corresponding to respective pixels of the second image, and
infer depth information of the pixel correction position in the second image by using a learned model learned by machine learning.

21. The information processing apparatus according to claim 20, wherein
the learned model is a neural network configured to output the corrected third image by learning using the third image having a defect in depth information and the pixel correction position as inputs.

22. The information processing apparatus according to claim 20, wherein
the learned model is a neural network configured to output the corrected third image by unsupervised learning using the third image without defect as an input.

23. An information processing method in which an information processing apparatus is configured to,
when generating a third image by mapping a first image in which an object acquired by a first sensor is indicated by depth information onto an image plane of a second image in which an image of the object acquired by a second sensor is indicated by color information,
map a first position on an image plane of the second image on a basis of depth information of the first position corresponding to each pixel of the first image,
specify, as a pixel correction position, a second position to which depth information of the first position is not assigned among second positions corresponding to respective pixels of the second image, and
infer depth information of the pixel correction position in the second image using a learned model learned by machine learning.

24. A program for causing a computer to function as an information processing apparatus including a processing unit that generates a third image by mapping a first image in which an object acquired by a first sensor is indicated by depth information onto an image plane of a second image in which an image of the object acquired by a second sensor is indicated by color information, wherein
the processing unit is configured to,
map a first position on an image plane of the second image on a basis of depth information of the first position corresponding to each pixel of the first image,
specify, as a pixel correction position, a second position to which depth information of the first position is not assigned among second positions corresponding to respective pixels of the second image, and
infer depth information of the pixel correction position in the second image using a learned model learned by machine learning.

25. A program for causing a computer to function as an information processing apparatus including a processing unit that generates a third image by mapping a second image in which an image of an object acquired by a second sensor is indicated by color information onto an image plane of a first image in which the object acquired by a first sensor is indicated by depth information, wherein
the processing unit is configured to,
specify, as a pixel correction position, a first position to which valid depth information is not assigned among first positions corresponding to respective pixels of the first image,
infer depth information of the pixel correction position in the first image using a learned model learned by machine learning, and
sample color information from a second position in the second image on a basis of depth information assigned to the first position to map the second position to the image plane of the first image.

26. The information processing apparatus according to claim 25, wherein
the learned model is a neural network configured to output the corrected depth information by learning using the first image having a defect and the pixel correction position as inputs.

27. An information processing method in which an information processing apparatus is configured to,
when generating a third image by mapping a second image in which an image of an object acquired by a second sensor is indicated by color information onto an image plane of a first image in which the object acquired by a first sensor is indicated by depth information,
specify, as a pixel correction position, a first position to which valid depth information is not assigned among first positions corresponding to respective pixels of the first image,
infer depth information of the pixel correction position in the first image using a learned model learned by machine learning, and
sample color information from a second position in the second image on a basis of depth information assigned to the first position to map the second position to the image plane of the first image.

28. A program for causing a computer to function as an information processing apparatus including a processing unit that generates a third image by mapping a second image in which an image of an object acquired by a second sensor is indicated by color information onto an image plane of a first image in which the object acquired by a first sensor is indicated by depth information, wherein
the processing unit is configured to,
specify, as a pixel correction position, a first position to which valid depth information is not assigned among first positions corresponding to respective pixels of the first image,
infer depth information of the pixel correction position in the first image using a learned model learned by machine learning, and
sample color information from a second position in the second image on a basis of depth information assigned to the first position to map the second position to the image plane of the first image.
